(19) United States
(12) Patent Application Publication
(10) Pub. No.: US 2014/0195172 A1
(43) Pub. Date: Jul. 10, 2014

(54) Static Fluid Sensor in Communication with a Multi-Sensing Device and Method of Operating

(71) Applicants: Kevin Le, Richland Hills, TX (US); Bryce Gaston, Dallas, TX (US)

(72) Inventors: Kevin Le, Richland Hills, TX (US); Bryce Gaston, Dallas, TX (US)

(73) Assignee: Luraco Technologies, Inc., Arlington, TX (US)

(21) Appl. No.: 13/734,203

(22) Filed: Jan. 4, 2013

(51) Int. Cl. G01N 7/10; G06F 17/00; G01F 1/34

(52) U.S. Cl. CPC G01N 7/10; G01F 1/34; G06F 17/00
USPC 702/47; 702/50

(57) ABSTRACT

A system including a flow sensor coupled to a fluid line and operable to determine flow rate data of a fluid flowing through the fluid line and communicate the flow rate data of the fluid to a multi-sense device. The multi-sense device coupled to the fluid line and operable to monitor characteristics of the fluid flowing through a filter element. The multi-sense device including a microcontroller coupled to a first, second, and third sensors. The microcontroller executing instructions for determining a pressure differential across the filter element using the flow rate data from the flow sensor, the first pressure of the fluid from the first sensor, the second pressure of the fluid from the second sensor, and the temperature of the fluid from the temperature sensor.

### GOVERNMENT LICENSE RIGHTS

The U.S. Government has a paid-up license in this invention and the right in limited circumstances to require the patent owner to license others on reasonable terms as provided for by the terms of contract no. W91IW6-08-C-0017 awarded by U.S. Army Research, Development, and Engineering Command (contract issued by Aviation Applied Technology Directorate).

### BACKGROUND

Hydraulic systems are often used in various mechanical systems or electro-mechanical systems to actuate and/or control components of those systems. For example, in an aircraft system, a hydraulic system may use a fluid, such as oil, to actuate controllers, motors, gears, and other components of the aircraft system. As the fluid flows through the hydraulic system, the fluid may be contaminated with particles from various components of the aircraft system. The fluid needs to be filtered and cleaned so that the hydraulic system performs and operates properly. Accordingly, the hydraulic system typically employs a filter assembly that includes a filter element for filtering the fluid. Over time, the filter element may become condemned or contaminated. In some circumstances, the condemned filter element can adversely affect the flow of the fluid (e.g., pressure) in the hydraulic system thereby degrading the performance of the hydraulic system and causing components of the aircraft system to operate improperly. Thus, it is important to accurately monitor and detect when the filter element and/or the fluid in the hydraulic system requires changing.

Traditional devices used to monitor and detect when the filter element requires changing fail to properly consider the flow rate of the hydraulic fluid. In that regard, traditional devices assume the flow rate of the hydraulic fluid remains constant. However, the flow rate of the hydraulic fluid typically varies depending upon the maneuvers being performed by the machine, for example an aircraft, in which the hydraulic fluid exists. Thus, when the flow rate of the hydraulic fluid is different from the assumed constant flow rate these traditional systems have difficulty in properly monitoring and detecting when the filter element requires changing.

Therefore, what is needed is a new and improved multi-sensing system for sensing characteristics of a fluid flowing through a filter element in a fluid system.

### SUMMARY

In one exemplary aspect, the present disclosure is directed to a flow sensor. The flow sensor has a bore defined by a body of the flow sensor and extends through the flow sensor. The bore has a non-uniform cross-sectional shape. The flow sensor includes an inlet portion coupled to a first hydraulic line portion and operable to deliver a hydraulic fluid into the bore. Also, the flow sensor has an outlet portion coupled to a second hydraulic line portion and operable to deliver the hydraulic fluid away from the bore. The flow sensor also includes an inlet pressure sensor operable to monitor and detect an inlet pressure of the hydraulic fluid in a proximal portion of the bore. Additionally, the flow sensor includes a temperature sensor operable to monitor and detect a temperature of the hydraulic fluid in a middle portion of the bore. Furthermore, the flow sensor has an outlet pressure sensor operable to monitor and detect an outlet pressure of the hydraulic fluid in a distal portion of the bore. In addition, the flow sensor has a microcontroller in communication with the inlet pressure sensor, temperature sensor, and outlet pressure sensor and is operable to receive and process the inlet pressure, the temperature, and the outlet pressure to determine a flow rate of the hydraulic fluid.

In one exemplary aspect, the present disclosure is directed to a system. The system includes a flow sensor coupled to a fluid line and operable to determine flow rate data of a fluid flowing through the fluid line and communicate the flow rate data of the fluid to a multi-sense device. The system further includes the multi-sense device coupled to the fluid line and operable to monitor characteristics of the fluid flowing through a filter element. The multi-sense device includes a first sensor operable to sense a first pressure of the fluid on a first side of the filter element. The multi-sense device also includes a second sensor operable to sense a second pressure of the fluid on a second side of the filter element. Additionally, the multi-sense device has a third sensor operable to sense a temperature of the fluid. Furthermore, the multi-sense device has an indicator for indicating a condition of the filter element. In addition, the multi-device includes a microcontroller coupled to the first, second, and third sensors. The microcontroller executes instructions for receiving the flow rate data from the flow sensor, the first pressure of the fluid from the first sensor, the second pressure of the fluid from the second sensor; and the temperature of the fluid from the temperature sensor; determining a pressure differential across the filter element using the flow rate data from the flow sensor, the first pressure of the fluid from the first sensor, the second pressure of the fluid from the second sensor, and the temperature of the fluid from the temperature sensor; determining whether the temperature exceeds a temperature threshold; if the temperature exceeds the temperature threshold, determining whether the determined pressure differential exceeds a pressure differential threshold; and if the determined pressure differential exceed the pressure differential threshold, activating the indicator to indicate a change to the condition of the filter element.

In one exemplary aspect, the present disclosure is directed to a method. The method includes receiving actual flow rate data representing an actual flow rate of a fluid flowing through a fluid system. The actual flow rate data is generated by sensing the fluid flowing through the fluid system. Also, the method includes receiving a first sensed pressure of the fluid from an inlet pressure sensor. The inlet pressure sensor is on an inlet side of a filter element. Additionally, the method includes receiving a second sensed pressure of the fluid from an outlet pressure sensor. The outlet pressure sensor is on an outlet side of the filter element. The method further includes receiving a sensed temperature of the fluid from a temperature sensor. The method also includes determining a pressure differential across the filter element using the flow rate data. The first sensed pressure, the second sensed pressure, and the sensed temperature. Furthermore, the method includes determining whether the sensed temperature exceeds a temperature threshold. If the sensed temperature exceeds the temperature threshold, determining whether the determined pressure differential exceeds a pressure differential threshold. If the determined pressure differential exceed the pressure differential threshold, determining that the filter element is in a condemned condition.

### BRIEF DESCRIPTION OF THE DRAWINGS

Aspects of the present disclosure are best understood from the following detailed description when read with the accompanying figures.

FIG. 1 illustrates a block diagram depicting a hydraulic system according to various aspects of the present disclosure.

FIG. 2 illustrates a perspective view of a static flow sensor used in the hydraulic system depicted in FIG. 1.

FIG. 3 illustrates a cross-sectional view of the static flow sensor depicted in FIG. 2.

FIG. 4 illustrates a block diagram depicting a hardware configuration of the static flow sensor depicted in FIGS. 1-3.

FIG. 5 illustrates a flowchart of a method for determining a flow rate of fluid flowing through the static flow sensor depicted in FIGS. 1-4.

FIG. 6 illustrates a diagrammatic representation of a portion of the hydraulic system depicted in FIG. 1

FIG. 7 illustrates a perspective view of a multi-sensing assembly depicted in FIG. 6.

FIG. 8 illustrates an exploded view of the multi-sensing device of FIG. 7 depicting a multi-sense device.

FIG. 9 illustrates a pressure sensor circuit of the multi-sensing device of FIG. 8 logically positioned on both an inlet side and an outlet side of a filter element of a filter assembly.

FIG. 10 illustrates a block diagram of a hardware configuration of the multi-sensing device of FIG. 8.

FIG. 11 illustrates a flowchart of a method for calibrating the multi-sensing device depicted in FIG. 8.

FIG. 12 illustrates a flow chart of a method for operation of the multi-sensing device of FIG. 8 that includes consideration of a current flow rate of a fluid within the hydraulic system depicted in FIG. 1.

FIG. 13 illustrates a flowchart of a method for determining a pressure differential across a filter element using the current flow rate of the hydraulic fluid.

FIG. 14 illustrates a flowchart of a method for sleep mode operation of the multi-sensing device of FIG. 8.

FIG. 15 illustrates a flowchart of a method for connecting a computing device to the multi-sensing device of FIG. 8.

FIG. 16 illustrates a flowchart of a method for data extraction from the multi-sensing device of FIG. 8.

FIG. 17 illustrates a flowchart of a method for configuring threshold values for the multi-sensing device of FIG. 8.

FIG. 18 illustrates a flowchart of a method for programming firmware for the multi-sensing device of FIG. 8.

FIG. 19 illustrates a flowchart of a method for disconnecting a computing device from the multi-sensing device of FIG. 8.

FIG. 20 illustrates a flowchart of a method for operation of the multi-sensing device of FIG. 8 during a filter element change.

### DETAILED DESCRIPTION

The present invention relates generally to checking parameters associated with components in a hydraulic system. It is understood, however, that the following disclosure provides many different embodiments, or examples, for implementing different features of the invention. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

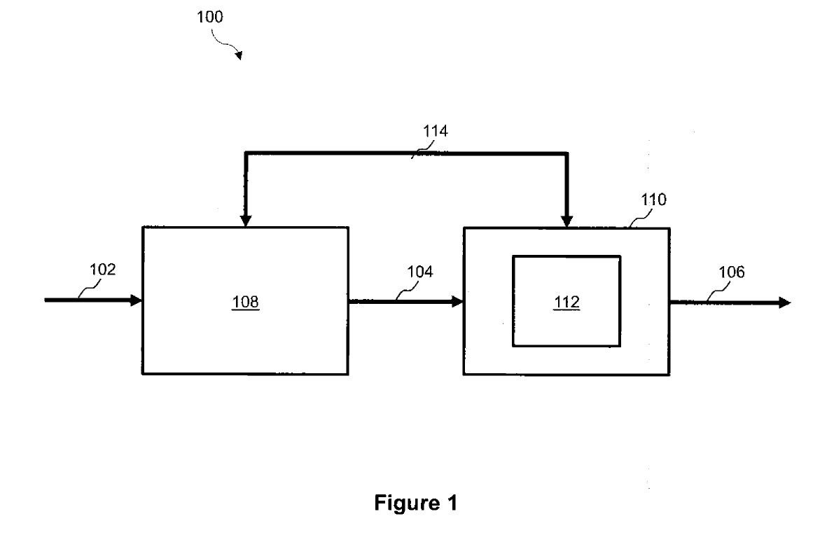

FIG. 1 illustrates a diagrammatic representation depicting a hydraulic system 100 according to various aspects of the present disclosure. As shown, hydraulic system 100 includes hydraulic line portions 102-106, static flow sensor 108, multi-sensing assembly 110, filter element 112, and communication line 114. Static flow sensor 108 is fluidly coupled to multi-sensing assembly 110 via hydraulic line portion 104 and is communicatively coupled to multi-sensing assembly 110 via communication line 114. Static flow sensor 108 receives hydraulic fluid from hydraulic line portion 102 which is then sent via hydraulic line portion 104 to multi-sensing assembly 110 and filter element 112. Hydraulic fluid flows out of multi-sensing assembly 110 and filter element 112 via hydraulic line portion 106.

As will be described in greater detail below, static flow sensor 108 determines the current (or actual or real-time) flow rate of the hydraulic fluid flowing through static flow sensor 108 and communicates the current flow rate of the hydraulic fluid to multi-sensing assembly 110 via communication line 114. By taking into account the current flow rate of the hydraulic fluid, multi-sensing assembly 110 more accurately monitors and detects when the filter element 112 requires changing when compared to traditional devices that assume a constant hydraulic fluid flow rate.

Moreover, as described below, static flow sensor 108 uses no moving parts to sense the flow rate of fluid flowing through the sensor. Thus, the sensor is considered a static sensor because no moving parts are used to sense the flow rate of fluid flowing through the sensor. Therefore, maintenance and complexity of static flow sensor 108 is reduced in comparison to other flow sensors that have moving parts.

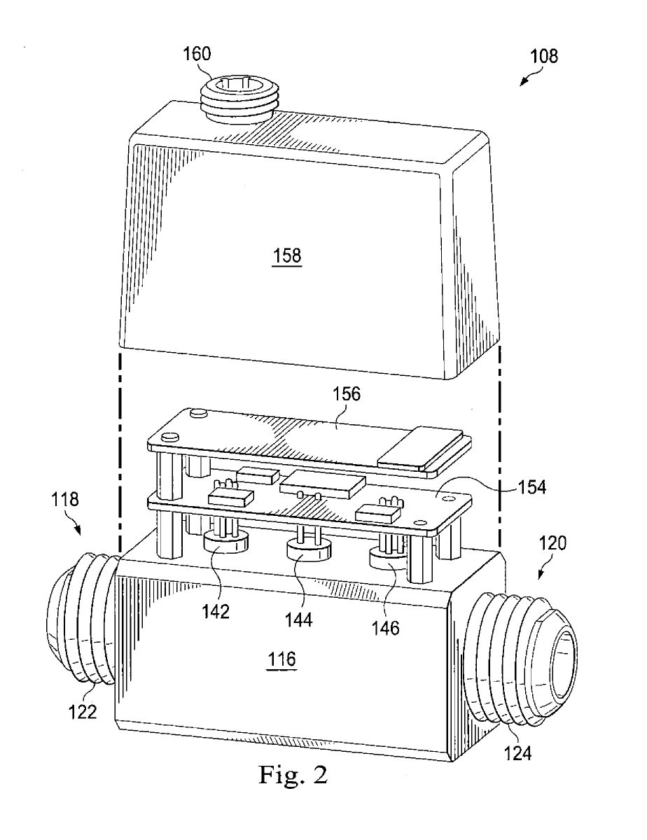

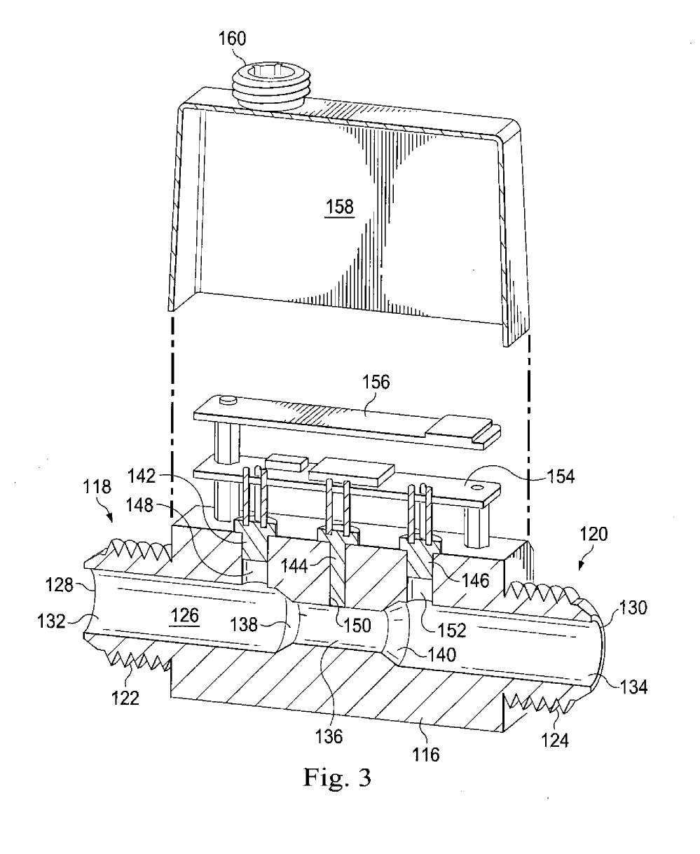

FIG. 2 illustrates a perspective view of the static flow sensor 108. FIG. 3 illustrates a cross-sectional view of the static flow sensor 108. Static flow sensor 108 has a body 116 defining an inlet (or upstream) portion 118 and an outlet (or downstream) portion 120. The inlet and outlet portions 118 and 120 include couplers 122 and 124, respectively. Couplers 122 and 124 are configured to couple static flow sensor 108 to hydraulic line portions 102 and 104, respectively. Here, couplers 122 and 124 are threaded to allow for static flow sensor 108 to be coupled to hydraulic line portions 102 and 104, respectively. However, in other embodiments couplers 122 and 124 can include any other coupling mechanism, such as slip-fit, snap-fit, epoxy, etc., to couple static flow sensor 108 to hydraulic line portions 102 and 104, respectively.

Body 116 additionally defines bore (or lumen) 126 extending through the static flow sensor 108 from the inlet portion 118 to the outlet portion 120. The inlet portion 118 defines an opening 128 that is in communication with bore 126 and outlet portion 120 defines an opening 130 that is in communication with bore 126.

Bore 126 has a proximal portion 132 positioned within the inlet portion 118 and a distal portion 134 positioned within the outlet portion 120. Proximal portion 132 and distal portion 134 each have a respective substantially constant diameter. Here, proximal portion 132 and distal portion 134 have substantially the same constant diameter. Proximal portion 132 is in fluid communication with hydraulic line portion 102 and distal portion 134 is in fluid communication with hydraulic line portion 104.

Extending between proximal portion 132 and distal portion 134 is middle portion 136. Middle portion 136 has a smaller diameter than proximal portion 132 and distal portion 134. As shown, middle portion 136 is in fluid communication with proximal portion 132 and distal portion 134 via transition portions 138 and 140, respectively. Transition portion 138 tapers (or slopes) from the proximal portion 132 to middle portion 136 and transition portion 140 tapers (or slopes) from distal portion to middle portion 136. In that regard, because transition portions 138 and 140 reduce the diameter of bore 126 in the middle portion 136 static flow sensor 108 is better able to detect and monitor changes in pressure with respect to the hydraulic fluid flowing through bore 126. Accordingly, bore 126 has a non-uniform (or non-constant) cross-sectional shape as the bore extends from the proximal portion 132 to the distal portion 134.

Static flow sensor 108 further includes inlet (or upstream) pressure sensor 142, temperature sensor 144, and outlet (or downstream) pressure sensor 146. Inlet pressure sensor 142 is in fluid commination with the proximal portion 132 of bore 126 via passageway 148. Outlet pressure sensor 1426 is in fluid commination with the distal portion 134 of bore 126 via passageway 152. Temperature sensor 144 is in fluid commination with the middle portion 136 of bore 126 via passageway 150. As such, inlet pressure sensor 142 and outlet pressure 146 monitor and detect the pressure of hydraulic fluid in the inlet and outlet portions of bore 126, respectively, and temperature sensor 144 detects and monitors the temperature of the hydraulic fluid in the middle portion 136 of bore 126.

As shown, inlet pressure sensor 142, temperature sensor 144, and outlet pressure sensor 146 are coupled to printed circuit board 154. Printed circuit board 154 includes various electronic components utilized in the detecting and monitoring of fluid flow rate. For example, printed circuit board 154 can include processors, microcontrollers, sensory circuits, filters, and/or embedded algorithms associated therewith used to obtain the measured pressures from the inlet and outlet pressure sensors 142 and 146 as well as the measured temperature from temperature sensor 144 to monitor and detect the flow rate of fluid through bore 126.

Also coupled to printed circuit board 154 is energy harvesting circuit 156. In that regard, energy harvesting circuit 156 harvests energy in order to provide power to the various components of static flow sensor 108. For example, energy harvesting circuit 156 is a vibration energy harvesting circuit that harvests vibration energy and converts it into electrical energy for powering the components of static flow sensor 108. In some embodiments, energy harvesting circuit 156 is coupled to a rechargeable battery such that the energy harvesting circuit 156 harvests vibration energy and converts it into electrical energy for recharging the battery.

Static flow sensor 108 includes a cover 158. Cover 158 covers and protects the energy harvesting circuit 156, printed circuit board 154, inlet pressure sensor 142, outlet pressure sensor 146, and temperature sensor 144 as well as other components of static flow sensor 108. Also, cover 158 includes a communication port 160 configured to allow for communication line 114 to couple to static flow sensor 108 and pass there through to communicate with components associated with printed circuit board 154.

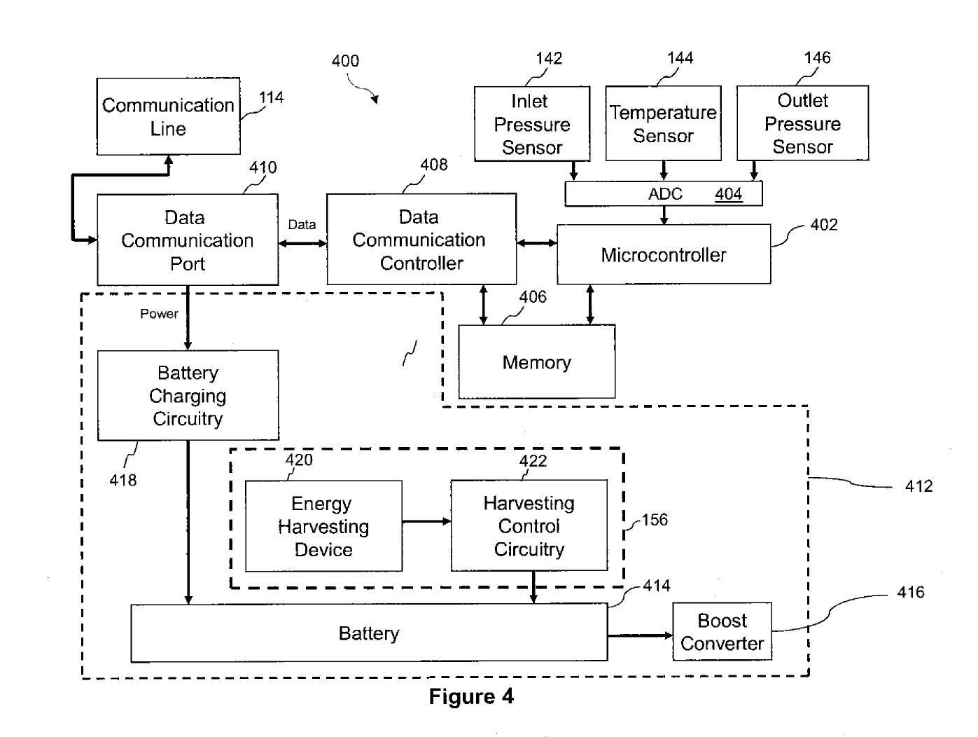

FIG. 4 illustrates a block diagram 400 depicting a hardware configuration of the static flow sensor 108. Similar features in FIGS. 1-3 are numbered the same for clarity. The block diagram 400 includes the inlet pressure sensor 142, the temperature sensor 144, and the outlet pressure sensor 146. The sensors 142, 144, and 146 are coupled to an analog-to-digital converter (ADC) 404. The ADC 404 receives analog signals from the sensors circuits 142, 144, and 146 and converts these analog signals into digital signals that are processed and managed by a microcontroller 402. The microcontroller 402 is the central processing unit in the hardware configuration of the static flow sensor 108. Here, ADC 404 is externally coupled to the microcontroller 402. In other embodiments, ADC 404 is internal to the microcontroller 402.

Coupled to microcontroller 402 is a memory 406. Memory 406 is a flash memory configured to store data received from microcontroller 402. For example, memory 406 stores various data including the pressure readings from the inlet and outlet pressure sensors 142 and 146 as well as the temperature reading from temperature sensor 144. Additionally, memory 406 can include various algorithms used to calculate the sensed pressures by inlet and outlet pressure sensors 142 and 146, the sensed temperature by temperature sensor 144, and the flow rate of fluid through the static flow sensor.

Data communication controller 408 is coupled to the microcontroller 402 and provides control and management of a data communication port 410. As shown, data communication port 410 is coupled to communication line 114. This coupling allows for data processed by the microcontroller 402, such as the current flow rate of hydraulic fluid flowing through static flow sensor 108, to be communicated to multi-sensing assembly 110.

Although, data communication port 410 is shown as being coupled to communication line 114 it should be understood that data communication port 410 allows for static flow sensor 108 to communicate with other devices besides multi-sensing assembly 110. In that regard, data communication port 410 and communication controller 408 enable the static flow sensor 108 to communicate with any device in any protocol as is known in the art. For example, the data communication port 410 may connect to a diagnostic or computing device, so that data may be uploaded from the static flow sensor 108 from the memory 406 for diagnostic and/or maintenance purposes. Additionally, data communication port 410 allows for modifying and/or reprogramming of any firmware stored on memory 406. Accordingly, data communication port 410 and communication controller 408 allow for two way communication with other devices such that static flow sensor 108 is customized by a user for their particular fluid system.

Additionally, the block diagram 400 of the static flow sensor 108 includes a power supply 412 that provides power to the static flow sensor 108. Power supply 412 includes a rechargeable battery 414 that provides power to the static flow sensor 108. The battery 414 is coupled to a boost converter circuit 416 that boosts the battery voltage to a desired level for use in powering the static flow sensor 108. The power supply 412 further includes a battery charging circuitry 418 that charges the battery 414. For example, the battery charging circuitry 418 may use the power provided by the data communication port 410 to charge the battery 414.

Additionally, power supply 412 includes energy harvesting circuit 156. Energy harvesting circuit 156 includes an energy harvesting device 420 and an energy harvesting control circuitry 422 to provide power to the static flow sensor 108. In that regard, energy harvesting device 420 harvests energy and converts it into electrical energy and passes it to harvesting control circuitry 422. Harvesting control circuitry 422 processes and controls the harvested electrical energy received from energy harvesting device 420 and utilizes the electrical energy to recharge battery 414. Accordingly, static flow sensor 108 may generate its own power, independent from power provided by a machine, such as an aircraft, in which the static flow sensor resides.

Moreover, the energy harvesting device 420 and the energy harvesting control circuitry 422 provide power to the static flow sensor 108 without dependence on battery 414 and therefore, use of the energy harvesting device 420 and the energy harvesting control circuitry 422 may prevent depletion of battery 414 while the static flow sensor is in use. In one embodiment, the energy harvesting device 420 includes a vibration energy harvesting device that translates energy from ambient vibrations into electrical energy. In that regard, hydraulic system 100 may be used in a hydraulic system of an aircraft that exhibits vibration energy in the regime of 5 to 50 Hz and therefore, the energy harvesting device 420 is specified to work in this range. Alternatively, the energy harvesting device 420 may include a heat or light energy harvesting device that translates energy from ambient heat or light into electrical energy. In a further alternative embodiment, a machine, such as an aircraft, in which the static flow sensor 108 resides, supplies power to static flow sensor 108. Further, the static flow sensor 108 may be powered by any suitable low voltage system.

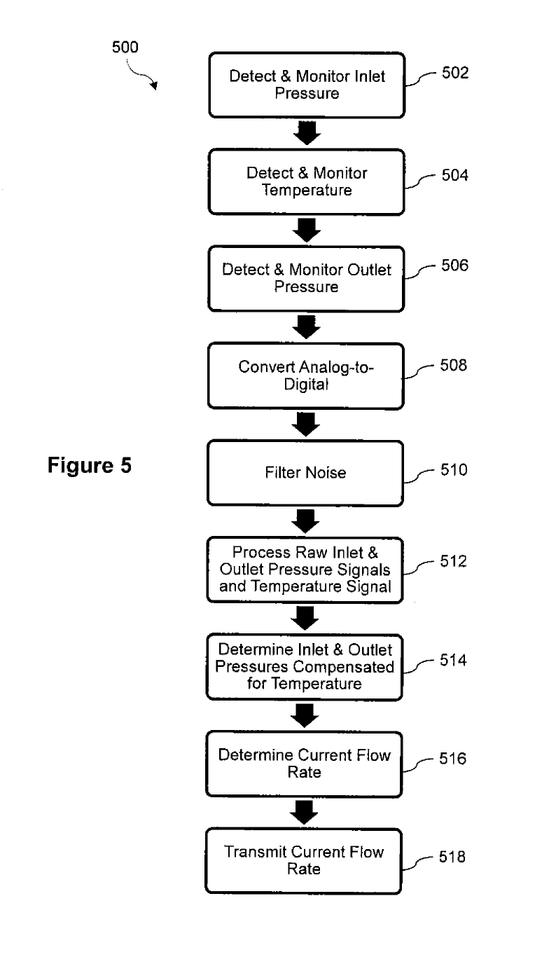

FIG. 5 illustrates a method 500 of determining a flow rate of fluid flowing through the static flow sensor 108. At step 502, static flow sensor 108 receives fluid, for example hydraulic fluid, from hydraulic line portion 102 into the proximal portion 132 of bore 126. Inlet pressure sensor 142 detects and monitors the pressure of the hydraulic fluid in the proximal portion 132 of bore 126. At step 504, the hydraulic fluid then flows from the proximal portion 132 into the middle portion 136 of bore 126 where temperature sensor 144 detects and monitors the temperature of the hydraulic fluid. Next at step 506, the hydraulic fluid flows from the middle portion 136 into the distal portion 134 of bore 126 where outlet pressure sensor 146 detects and monitors the pressure of the hydraulic fluid in the distal portion 134 of bore 126. The detected pressure by inlet pressure sensor 142 and outlet pressure sensor 146 as well as the detected temperature by temperature sensor 144 can be stored in memory 406 of static flow sensor 108.

At step 508, analog-to-digital converter 404 receives the analog signals from the sensors 142, 144, and 146 and converts these analog signals into digital signals. Then, at step 510, the digital pressure signals are subjected to a digital filter which removes anomalies/electrical noise from the digital pressure signals. At step 512, the microcontroller 402 receives the filtered digital pressure signals and the digital temperature signal. The microcontroller 402 processes the filtered digital pressure signals into a raw inlet pressure signal and a raw outlet pressure signal that originated from the inlet and outlet pressure sensors 142 and 146, respectively. Also, the microcontroller 402 processes the digital temperature. In that regard, as one skilled in the art would understand, microcontroller 402 utilizes the Steinhart-Hart temperature equation to determine the temperature within bore 126. Microcontroller 402 stores the determined temperature in memory 406.

Next, at step 514, microcontroller 402 adjusts the raw inlet pressure signal and the raw outlet pressure signal by accounting for the affect that the determined temperature has on the respective pressures. In that regard, microcontroller 402 utilizes the following formula to determine the inlet pressure compensated for temperature:

$$Pcomp ( inlet ) = \{ \begin{matrix}( \frac{15}{{10}^{- 7.04 * {10}^{- 3} * ( T - 100 ) + 1.176}} ) * Praw ( inlet ) , 100 ° F . \leq T < 125 ° F . \\ ( \frac{15}{{10}^{- 6.2 * {10}^{- 3} * ( T - 125 ) + 1}} ) * Praw ( inlet ) , 125 ° F . \leq T < 150 ° F . \\ ( \frac{15}{{10}^{- 4.43 * {10}^{- 3} * ( T - 150 ) + 0.845}} ) * Praw ( inlet ) , 150 ° F . \leq T < 183 ° F . \\ ( \frac{15}{{10}^{- 3.73 * {10}^{- 3} * ( T - 183 ) + 0.699}} ) * Praw ( inlet ) , 183 ° F . \leq T < 209 ° F . \\ ( \frac{15}{{10}^{- 4.03 * {10}^{- 3} * ( T - 209 ) + 0.602}} ) * Praw ( inlet ) , 209 ° F . \leq T < 255 ° F .\end{matrix}$$

Wherein Pcomp(inlet) is the inlet pressure compensated for temperature; Praw(inlet) is the raw inlet pressure signal; and T is the temperature determined by microcontroller 402 utilizing the Steinhart-Hart temperature equation.

Additionally, microcontroller 402 utilizes the following formula to determine the outlet pressure compensated for temperature:

$$Pcomp ( outlet ) = \{ \begin{matrix}( \frac{15}{{10}^{- 7.04 * {10}^{- 3} * ( T - 100 ) + 1.176}} ) * Praw ( outlet ) , 100 ° F . \leq T < 125 ° F . \\ ( \frac{15}{{10}^{- 6.2 * {10}^{- 3} * ( T - 125 ) + 1}} ) * Praw ( outlet ) , 125 ° F . \leq T < 150 ° F . \\ ( \frac{15}{{10}^{- 4.43 * {10}^{- 3} * ( T - 150 ) + 0.845}} ) * Praw ( outlet ) , 150 ° F . \leq T < 183 ° F . \\ ( \frac{15}{{10}^{- 3.73 * {10}^{- 3} * ( T - 183 ) + 0.699}} ) * Praw ( outlet ) , 183 ° F . \leq T < 209 ° F . \\ ( \frac{15}{{10}^{- 4.03 * {10}^{- 3} * ( T - 209 ) + 0.602}} ) * Praw ( outlet ) , 209 ° F . \leq T < 255 ° F .\end{matrix}$$

Wherein Pcomp(outlet) is the outlet pressure compensated for temperature; Praw (outlet) is the raw inlet pressure signal; and T is the temperature determined by microcontroller 402 utilizing the Steinhart-Hart temperature equation.

Method 500 continues with step 516 in which the microcontroller utilizes the inlet and outlet pressures compensated for temperature to determine a current flow rate of the hydraulic fluid through bore 126 of static flow sensor 108. Microcontroller 402 utilizes the following formula to determine the current flow rate of the hydraulic fluid:

$$Q = {A}_{1} \sqrt{\frac{2}{ρ} * \frac{( Pcomp ( inlet ) - Pcomp ( outlet )}{{( \frac{{A}_{1}}{{A}_{2}} )}^{2} - 1}}$$

Wherein Q is the current flow rate of the hydraulic fluid flowing through bore 126 of static flow sensor 108; wherein A₁ is the cross-sectional area of the proximal portion 132 of bore 126; wherein A₂ is the cross-sectional area of the middle portion 136 of bore 126; wherein Pcomp(inlet) is the inlet pressure compensated for temperature; Pcomp(outlet) is the outlet pressure compensated for temperature; and wherein ρ is the density of the hydraulic fluid.

At step 518, microcontroller transmits the current flow rate of the hydraulic fluid flowing through bore 126 of static flow sensor 108 to multi-sensing assembly 110 via communication line 114. As discussed above, although data communication port 410 is shown as being coupled to communication line 114 which is coupled to multi-sensing assembly 110, it should be understood that data communication port 410 allows for static flow sensor 108 to communicate with other devices besides multi-sensing assembly 110. In that regard, data communication port 410 and communication controller 408 enable the static flow sensor 108 to communicate with any device in any protocol as is known in the art.

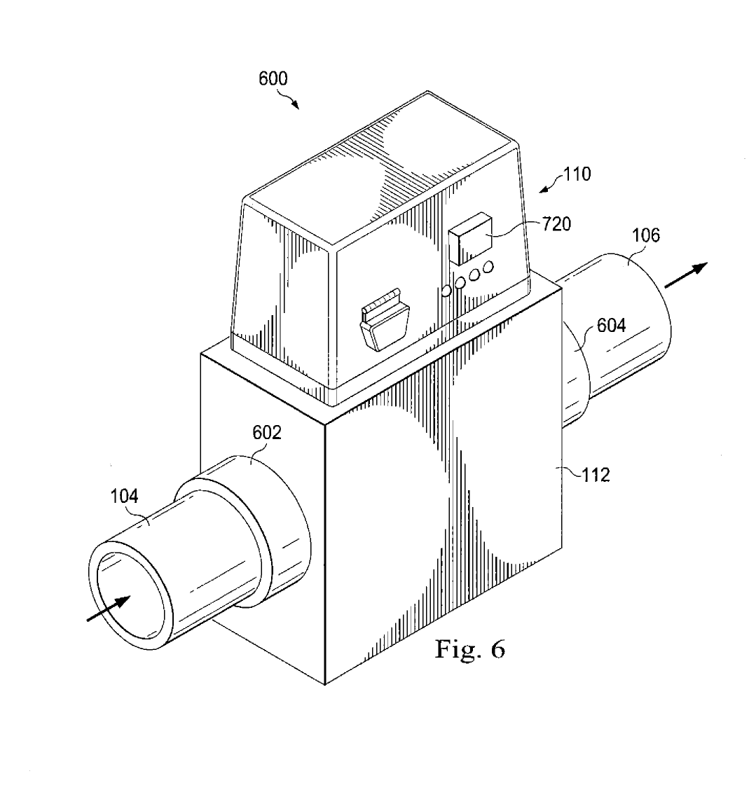

FIG. 6 illustrates a diagrammatic representation of a portion 600 of the hydraulic system 100 depicted in FIG. 1. The portion 600 of the hydraulic system 100 show in FIG. 6 includes multi-sensing assembly 110 and filter assembly 112. As shown, hydraulic line portions 104 and 106 are coupled to an inlet port 602 and an outlet port 604 associated with filter assembly 112. The hydraulic fluid flows into the inlet port 602, through the filter assembly 112, and then out the outlet port 604. Filter assembly 112 includes a filter element that filters the hydraulic fluid as it flows through the hydraulic lines. Also, the filter assembly 112 includes an opening for receiving a multi-sensing assembly 110. The multi-sensing assembly 110 includes an extended portion that fits into the filter assembly 112 in such a manner that a sensing portion of the multi-sensing assembly 110 contacts the hydraulic fluid as it flows through the filter assembly 112 as will be discussed in more detail below. Accordingly, the multi-sensing assembly 110 is capable of sensing and monitoring various characteristics of the hydraulic fluid as it flows through the filter assembly 112. The various characteristics of the hydraulic fluid can be used to provide a contamination/condemnation status of the filter element and hydraulic fluid in the filter assembly 112. It is understood that the hydraulic system 100 may be utilized to actuate and/or control components of various machines, mechanical systems, electro-mechanical systems, or other suitable systems. Thus, it is important to monitor and detect the contamination/condemnation status of the filter element and fluid in the filter assembly 112 so that the hydraulic system 100 is properly operating for its intended purpose.

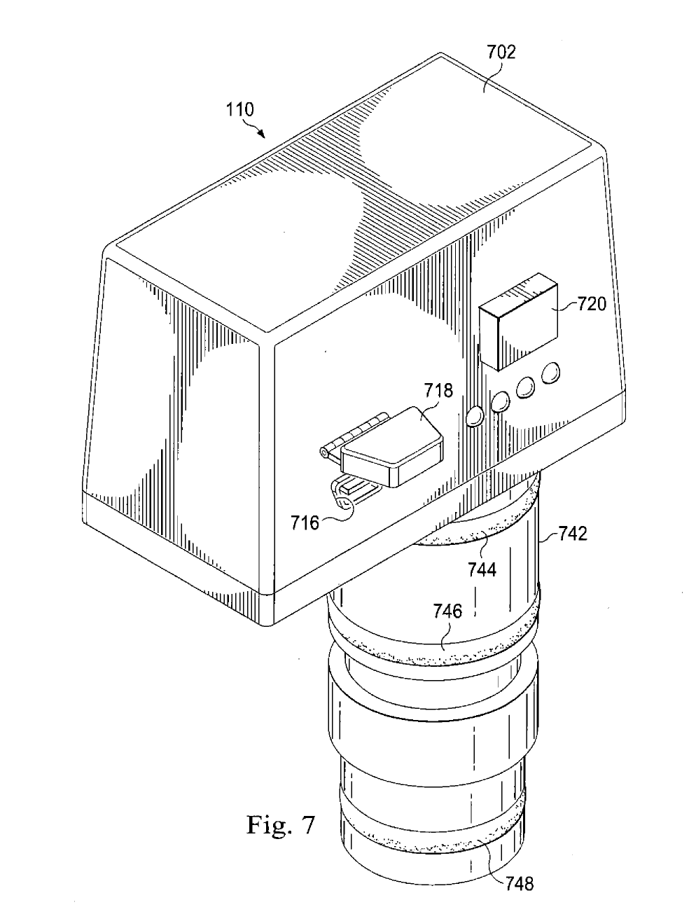

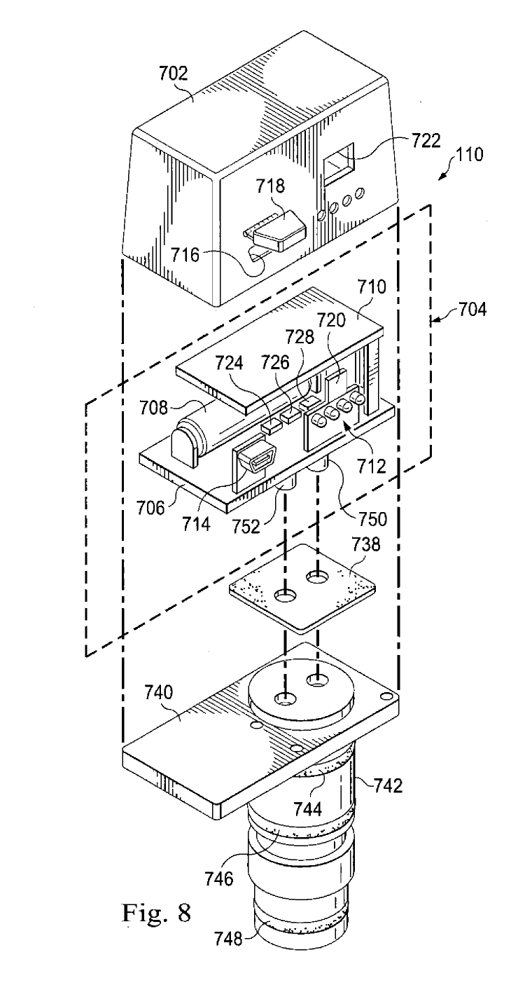

Referring to FIGS. 7 and 8, illustrated are a perspective view and an exploded view of the multi-sensing assembly 110, respectively, that may be implemented in the hydraulic system 100 of FIG. 1. The multi-sensing assembly 110 includes a top housing 702 that provides a casing for a multi-sensing device 704 (as best seen in FIG. 8). The multi-sensing device 704 senses and monitors various characteristics of the hydraulic fluid as it passes through the filter assembly 112 including the filter element. In the present embodiment, the multi-sensing device 704 includes a printed circuit board (PCB) 706. The multi-sensing device 704 includes a rechargeable battery 708 that is coupled to the PCB 706. The battery 708 provides power to the various components of the multi-sensing device 704. The multi-sensing device 704 further includes an energy harvesting circuit 710, for example a vibration energy harvesting circuit that is coupled to the PCB 706. The energy harvesting circuit 710 may harvest vibration energy and convert it into electrical energy for recharging the battery 708.

The multi-sensing device 704 also includes a plurality of status light-emitting-diodes (LEDs) 712 on the PCB 706. For example, the status LEDs 712 may include one of a pressure status LED, a temperature status LED, a fluid quality status LED, a battery status LED, and a data status LED. A blinking pressure status LED indicates that the multi-sensing device 704 is in a calibration mode of operation. A blinking pressure status LED, temperature status LED, or fluid quality LED indicates that a parameter of hydraulic system 100 is outside a preferred or a safe range of operation. Moreover, the data status LED is turned on to indicate that a data extraction application is in preparation to communicate with or is in communication with the multi-sensing device 704. It is understood that the number of status LEDs and the functionality of the status LEDs may vary depending on the particular application that the multi-sensing device 704 is used for.

The multi-sensing device 704 further includes a data communication port 714, for example a universal serial bus (USB) port, that allows the multi-sensing device 704 to connect to a computing device, such as a PC, laptop computer, personal digital assistant (PDA) or other suitable device, for calibration, diagnostic, maintenance, or other suitable purposes. Alternatively, the data communication port 714 may optionally be configured for other types of data communication interfaces as is known in the art. The computing device connects to the data communication port 714 through a data communication port opening 716 in the top housing 702. Moreover, the top housing 702 includes a data communication port cover 718 that protects the data communication port 714 from undesirable elements.

Further, the multi-sensing device 704 includes a wake/calibrate button 720 that is coupled to the PCB 706. The wake/calibrate button 720 is used to wake and calibrate the multi-sensing device 704. The top housing 702 has an opening 722 for the wake/calibrate button 720. The wake/calibrate button 720 protrudes through the opening 722 so that it can be depressed and activated by a user external to the multi-sensing device 704.

In addition, the multi-sensing device 704 includes a temperature sensor circuit 724, a pressure sensor circuit 726, and a fluid contamination sensor circuit 728. The sensor circuits 724, 726, and 728 are coupled to the PCB 706 and provide the multi-sensing device 704 with multi-sensing functionality. For example, the temperature sensor circuit 724 senses a temperature of the hydraulic fluid passing through the filter assembly 112. The pressure sensor circuit 726, for example, senses a pressure differential across the filter assembly 112. Moreover, the fluid contamination sensor circuit 728, for example, includes an optical absorption sensor circuit. The fluid contamination sensor circuit 728 senses an optical absorption of the hydraulic fluid that allows for a determination of various characteristics of the hydraulic fluid quality. For example, an optical absorption spectrum of the hydraulic fluid may be analyzed to determine the fluid quality. Hydraulic fluid that is clean exhibits an optical absorption structure that is different than hydraulic fluid that is contaminated. The optical absorption sensor may use a narrow wavelength bandwidth (e.g., infrared region) to detect when the fluid is contaminated. Further, the unique absorption signature of the hydraulic fluid may be analyzed to determine the fluid quality, such as, metallic particulate content, viscosity, water content, acidity, and oxidation. Alternatively, the fluid contamination sensor circuit 728 may optionally utilize other types of sensors such as a dielectric sensor or water-content sensor for sensing the fluid quality.

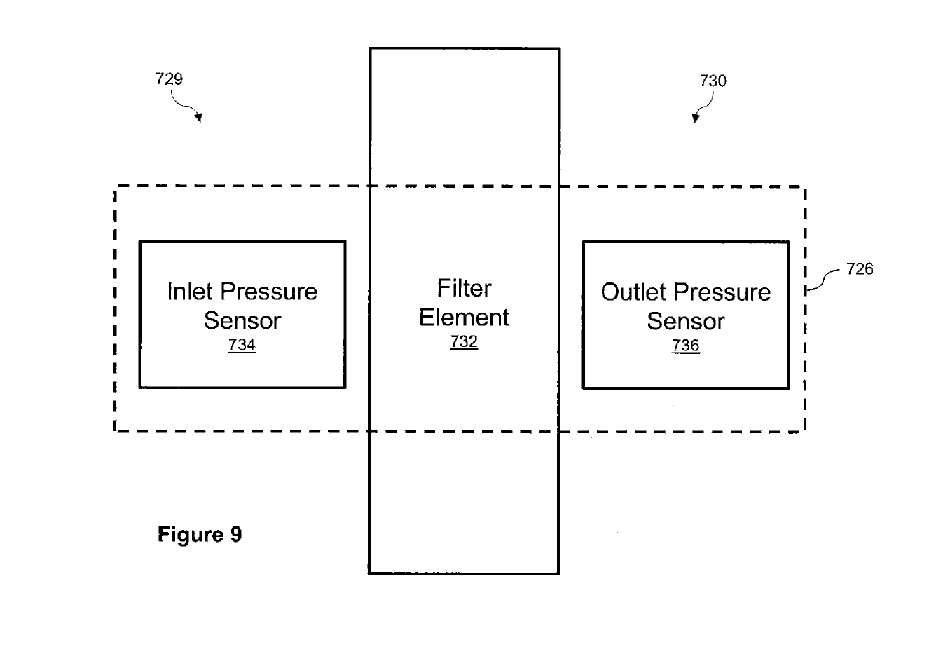

As discussed above, pressure sensor circuit 726 senses a pressure differential across the filter assembly 112. FIG. 9 illustrates pressure sensor circuit 726 logically positioned on both an inlet side 729 and an outlet side 730 of a filter element 732 of the filter assembly 112. In that regard, sensor circuit 726 includes an inlet (or upstream) pressure sensor 734 and outlet (or downstream) pressure sensor 736. Inlet pressure sensor 734 is in fluid commination with the filter assembly 112 on the inlet (or upstream) side of the filter element 732 associated with the filter assembly 112. As such, inlet pressure sensor 734 monitors and detects the pressure of hydraulic fluid on the inlet (or upstream) side of the filter element 732 associated with the filter assembly 112. Outlet pressure sensor 736 is in fluid commination with the filter assembly 112 on the outlet (or downstream) side of the filter element 732 associated with the filter assembly 112. As such, outlet pressure sensor 736 monitors and detects the pressure of hydraulic fluid on the outlet (or downstream) side of the filter element 732 associated with the filter assembly 112. As will be discussed in greater detail below, multi-sensing device 704 utilizes the inlet and outlet pressures monitored and detected by inlet and outlet pressure sensors 734 and 736, respectively, in determining the pressure differential across the filter assembly 112 for the purposes of determining filter contamination and/or condemnation.

The multi-sensing assembly 110 further includes a gasket 738 and a filter assembly interface 740. The gasket 738 provides a sealant between the filter assembly interface 740 and the multi-sensing device 704. The multi-sensing assembly 110 also includes a tubular extension 742 that fits into the filter assembly 112. The tubular extension 742 includes hydraulic fluid sealing rings 744, 746, and 748. The hydraulic fluid sealing rings 744, 746, and 748 provide a sealant between the tubular extension 742 and the hydraulic fluid in the filter assembly 112. The multi-sensing device 704 further includes ports 750 and 752 that protrude through the gasket 738, the filter assembly interface 740, and the tubular extension 742. The ports 750 and 752 protrude into the hydraulic fluid in the filter assembly 112. The hydraulic fluid is directed through the ports 750 and 752 to the sensing elements of the temperature sensor circuit 724, the pressure sensor circuit 726, and the fluid contamination sensor circuit 728.

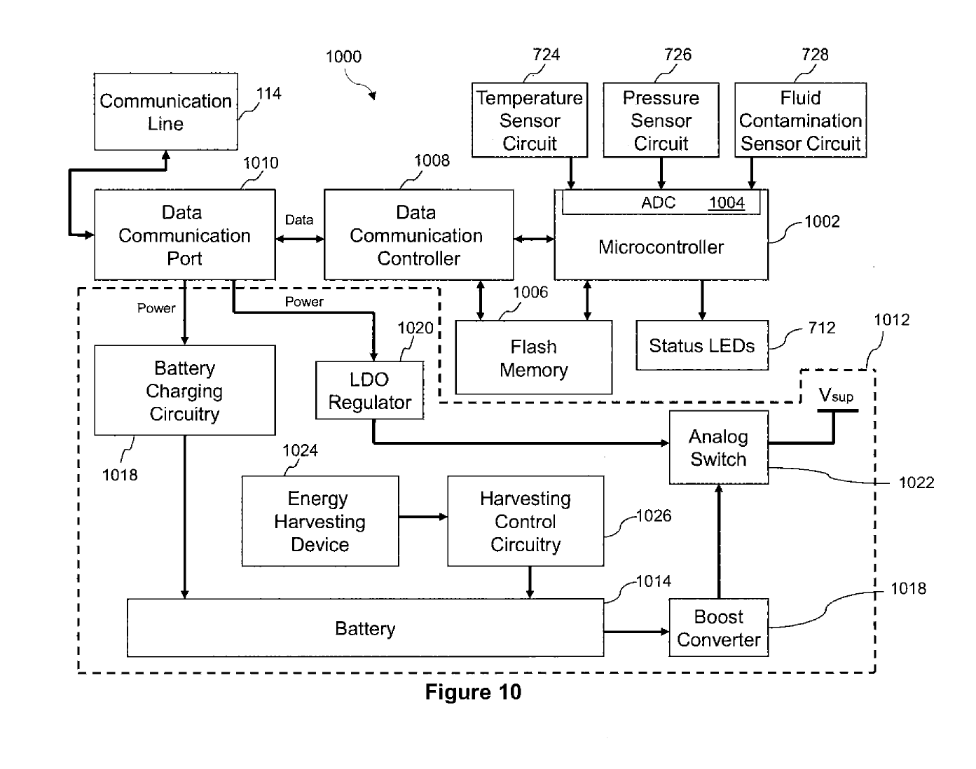

Referring to FIG. 10, illustrated is a block diagram 1000 of a hardware configuration of the multi-sensing device 704 that may be implemented in multi-sensing assembly 110 of FIGS. 1 and 6-8. Similar features are identified by the same reference numerals as used in FIGS. 1 and 6-8 for the sake of clarity. The block diagram 1000 includes the temperature sensor circuit 724, the pressure sensor circuit 726, and the fluid contamination sensor circuit 728. The sensor circuits 724, 726, and 728 are coupled to a processing device, such as microcontroller 1002. The microcontroller 1002 is the central processing unit in the hardware configuration of the multi-sensing device 704. The microcontroller 1002 includes an internal analog-to-digital converter (ADC) 1004. In an alternative embodiment, the ADC 1004 may optionally be external to the microcontroller 1002. In that case, the external ADC is coupled to the microcontroller 1002. The ADC 1004 receives signals from the sensors circuits 724, 726, and 728 and converts these analog signals into digital signals that are processed and managed by the microcontroller 1002. The microcontroller 1002 is further coupled to the status LEDs 712 for controlling and activating the status LEDs.

The block diagram 1000 of the hardware configuration of multi-sensing device 704 includes memory, for example a flash memory 1006. The flash memory 1006 is coupled to the microcontroller device 1002. In an alternative embodiment, the flash memory 1006 is integrated into the microcontroller device 1002. Furthermore, the flash memory 1006 is coupled to a data communication controller 1008. The flash memory 1006 stores various threshold values, for example a temperature threshold, a pressure differential threshold, a fluid quality threshold, and a threshold for elapsed time since a calibration of the multi-sensing device 704 was activated. The threshold values may be programmed initially and later re-programmed by a user using a data extraction application that engages with the multi-sensing device 704. It is understood the other threshold values may be provided as default or pre-defined threshold values that are specified by the manufacturer for a particular hydraulic system or for a particular type of hydraulic fluid.

The data communication controller 1008 is coupled to the microcontroller 1002 and provides control and management of a data communication port 1010. The data communication port 1010 and communication controller 1008 are in conformance with, for example, the universal serial bus (USB) communication protocol. In alternative embodiments, the data communication port 1010 and communication controller 1008 enables other communication protocols as is known in the art. The data communication port 1010 may connect to a diagnostic or computing device, such as a PC, so that data may be uploaded from the multi-sensing device 704 from the flash memory 1006 to the PC for diagnostic and/or maintenance purposes. To that extent, the PC includes the data extraction application. Moreover, the data extraction application further allows a user to set threshold values and re-program firmware into the flash memory 1006 via the data communication port 1010. Accordingly, this allows the multi-sensing device 704 to be customized by the user for their particular fluid system.

As shown, data communication port 1010 is coupled to communication line 114. This coupling allows for data processed by the microcontroller 402 in the static flow sensor 108, such as the current flow rate of hydraulic fluid flowing through static flow sensor 108, to be communicated to multi-sensing device 704. Thus, as discussed in more detail below, multi-sensing device 704 is able to consider the current flow rate of the hydraulic fluid in system 100 when determining the pressure differential threshold for the purposes of filter contamination and/or condemnation.

In addition, the block diagram 1000 of the multi-sensing device 704 also includes a power supply 1012 that provides power to the multi-sensing device 704. For example, the power supply 1012 includes a battery 1014 (such as the rechargeable battery 708 of FIG. 8) that provides power to the multi-sensing device 704. The battery 1014 is coupled to a boost converter circuit 1016 that boosts the battery voltage to a desired level for use in powering the multi-sensing device 704. The power supply 1012 further includes a battery charging circuitry 1018 that charges the battery 1014. For example, the battery charging circuitry 1018 may use the power provided by the data communication port 1010 to charge the battery 1014. In addition, the power provided by the data communication port 1010 may also be directed to a voltage regulator, such as a low dropout regulator (LDO) 1020. The LDO 1020 is coupled to an analog switch 1022. Also, the boost converter 1016 is coupled to the analog switch 1022. The analog switch 1022 may be selected to use power from the boost converter 1016 or the LDO 1020 to power the multi-sensing device 704.

In one embodiment, the energy harvesting circuit 710 includes an energy harvesting device 1024 and an energy harvesting control circuitry 1026 to provide power to the multi-sensing device 704. Accordingly, the multi-sensing assembly 110 may generate its own power, independent from power provided by a machine, such as an aircraft, in which the multi-sensing assembly 110 resides. Moreover, the energy harvesting device 1024 and the energy harvesting control circuitry 1026 provide power to the multi-sensing device 704 without dependence on the battery 1014 and therefore, use of the energy harvesting device 1024 and the energy harvesting control circuitry 1026 may prevent depletion of battery 1014 while the multi-sensing device 704 is in use. In one embodiment, the energy harvesting device 1024 includes a vibration energy harvesting device that translates energy from ambient vibrations into electrical energy. Alternatively, the energy harvesting device 1024 may include a heat or light energy harvesting device that translates energy from ambient heat or light into electrical energy. The multi-sensing assembly 110 is used in a hydraulic system of an aircraft that exhibits vibration energy in the regime of 5 to 50 Hz and therefore, the energy harvesting device 1024 is specified to work in this range. In an alternative embodiment, a machine, such as an aircraft, in which the multi-sensing assembly 110 resides, supplies power to the multi-sensing device 704. Further, the multi-sensing device 704 may be powered by any suitable low voltage system.

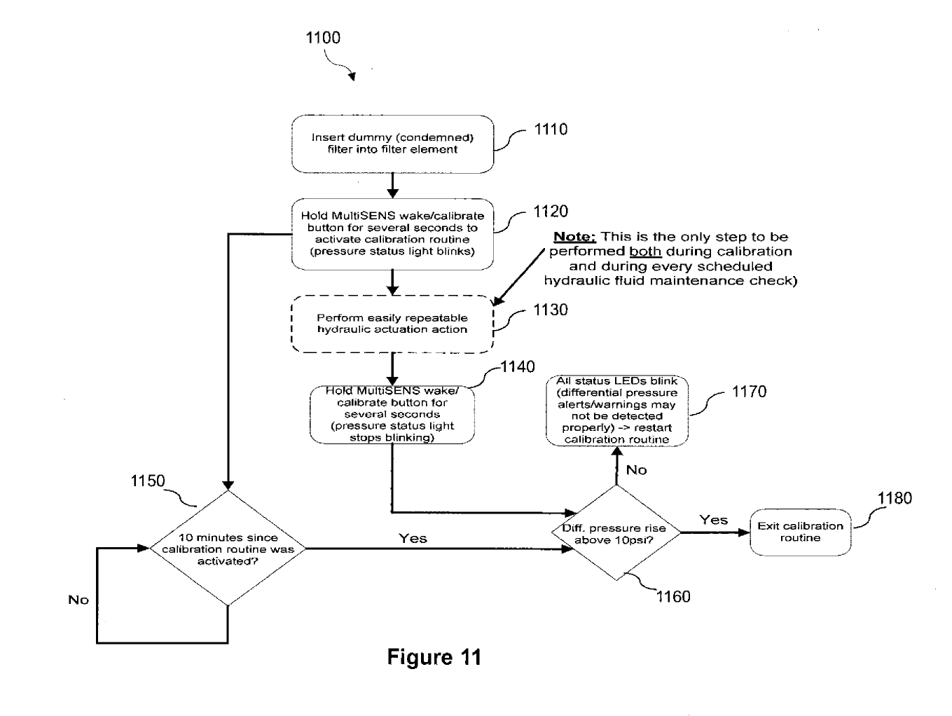

Referring also to FIG. 11, illustrated is a flowchart of a method 1100 for calibrating the multi-sensing device 704. The calibration procedure 1100 enables the multi-sensing device 704 to capture a pressure differential that is generated across a dummy filter element, thereby emulating a condemned filter element state in response to a known, easily repeatable hydraulic actuation action that a maintenance technician performs. The measured pressure differential correlates to a flow rate of the hydraulic fluid flowing through the condemned filter element state. Accordingly, the measured pressure differential provides a basis for automatically calculating a pressure alert threshold and a pressure warning threshold for the multi-sensing device 704. For example, the alert threshold may be set to 60% of the measured pressure differential, while the warning threshold may be set to 80% of the measured pressure differential. The specific percentages may vary depending on design requirements of a particular hydraulic system. To enhance the reliability of the multi-sensing device 704 for determining when the hydraulic fluid and/or filter element is near (e.g., alert threshold) or at (e.g., warning threshold) a point of requiring changing, a maintenance routine should include performing the same hydraulic actuation that was performed during calibration as part of scheduled hydraulic fluid maintenance checks. Accordingly, a pressure differential measured across the filter element during the maintenance routine may be compared to the pressure alert threshold and pressure warning threshold to accurately and reliably determine the condition of the filter element.

The calibration procedure 1100 should be performed immediately after the multi-sensing assembly 110 is installed in the hydraulic system 100, and periodically thereafter, for example every one to two years or other suitable time period, to ensure that condemnation of the filter element continues to be accurately detected. If the calibration procedure 1100 is not performed, or if the multi-sensing device 704 has been set to ignore the calibration derived thresholds, then the multi-sensing device 704 may use the threshold values that are programmed in the memory as the alert threshold level and warning threshold level. For example, the threshold values may include default threshold values provided by a maintenance technician or other user of the multi-sensing device, the default threshold values depending on requirements of a particular hydraulic system and/or hydraulic fluid.

The calibration procedure 1100 begins in block 1110 where a dummy filter is inserted into the filter assembly 112. The dummy filter emulates a condemned hydraulic filter element in the filter assembly 112. The calibration procedure 1100 continues in block 1120, where the wake/calibrate button 720 is depressed and held for several seconds to activate the calibration routine. One of the status LEDs 712 is a pressure status LED. The pressure status LED begins to blink once the multi-sensing device 704 has entered the calibration mode of operation. For example, the blinking exhibits a period of about two seconds and a duty cycle of about 50%. The calibration procedure 1100 proceeds to block 1130, where a maintenance technician performs an easily repeatable hydraulic actuation action. For example, the hydraulic actuation action should be performed during regularly scheduled hydraulic oil maintenance checks. Then, in block 1140, the wake/calibrate button 720 is held for several seconds once again. This will stop the pressure status LED from blinking and will turn off the pressure status LED, indicating that the multi-sensing device 704 is ready to prepare for exiting the calibration mode of operation.

The calibration procedure 1100 continues to block 1150, where the calibration routine determines how much time has elapsed since the calibration routine was activated. In other words, how much time has elapsed since the maintenance technician depressed and held the wake/calibrate button for several seconds (block 1120). If the elapsed time since calibration activation exceeds a predetermined threshold value, the multi-sensing device 704 prepares to exit the calibration routine and the pressure status LED stops blinking and turns off. In one example, the predetermined elapsed time threshold value is set to ten minutes. During the calibration procedure 1100, the calibration routine will check to determine if ten minutes or more has elapsed since the calibration mode of operation was activated. If ten minutes or more has elapsed since activation of the calibration routine, the multi-sensing device 704 automatically prepares to exit the calibration mode of operation, and the pressure status LED automatically turns off.

In preparation for exiting the calibration routine, in block 1160, the multi-sensing device 704 determines whether the pressure differential has risen above a predetermined value. For example, in one embodiment, the predetermined value is 10 psi. If the pressure differential does not rise above the predetermined value, the calibration procedure 1100 proceeds to block 1170 where for example, the status LEDs 712 start blinking to indicate that the calibration routine was not performed successfully. This informs the maintenance technician that the calibration routine must be performed again. If the pressure differential does rise above the predetermined value, the calibration procedure 1100 proceeds to block 1180, where the calibration routine is exited and the calibration procedure is complete.

Even using the calibration procedure 1100, it has been observed that multi-sense assemblies may not accurately determine the pressure differential. In that regard, traditional multi-sense devices that are used to monitor and detect filter contamination and/or condemnation fail to properly consider the flow rate of the hydraulic fluid. Specifically, traditional multi-sense devices assume that the flow rate of the hydraulic fluid remains constant as passing through the hydraulic system. However, it has been observed that the flow rate of the hydraulic fluid typically varies/fluctuates within a hydraulic line. Thus, when the current flow rate of the hydraulic fluid is different from the assumed constant flow rate these traditional systems have difficulty in properly monitoring and detecting the level/degree of filter contamination and/or condemnation. In fact, it has been observed in traditional multi-sense devices that assume a constant flow rate that the measured pressure differential can have an error of about +/−15% by not considering the current flow rate of the hydraulic fluid in the hydraulic system.

To address these issues, multi-sense device 704 of system 100 accounts for the current flow rate of the fluid within the system when determining the measured pressure differential. As discussed above, multi-sensing device 704 receives via communication line 114 the current flow rate of the hydraulic fluid flowing through static flow sensor 108. Thus, as will be discussed in greater detail below, multi-sensing device 704 considers the current flow rate of the hydraulic fluid when determining the pressure differential threshold for the purposes of filter contamination and/or condemnation.

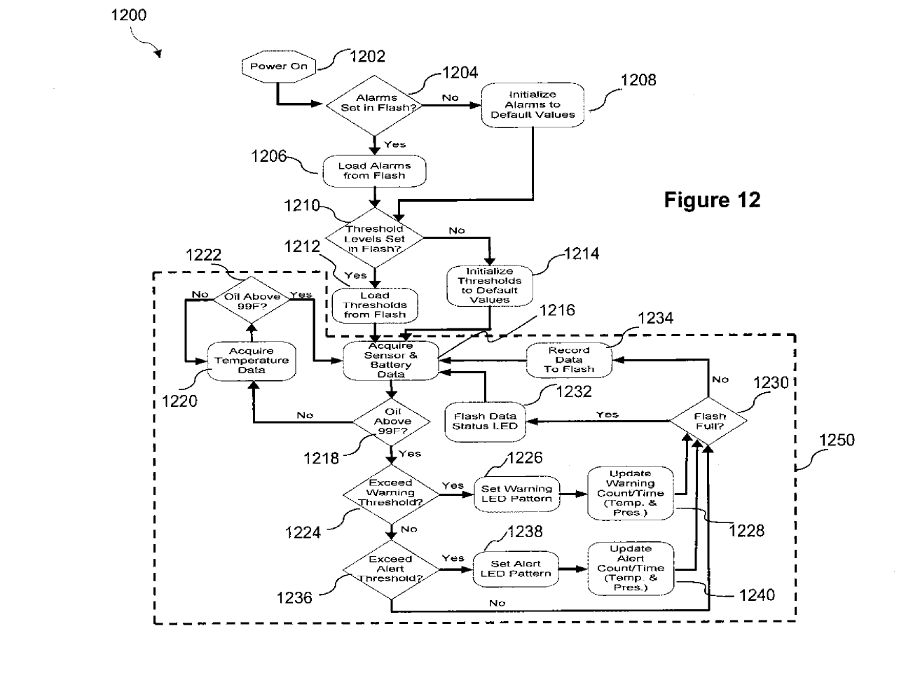

FIG. 12 illustrates a flow chart of a method 1200 for operation of the multi-sensing device 704 that includes consideration of the current flow rate of the fluid within hydraulic system 100. The method 1200 begins in block 1202 where the multi-sensing device 704 is powered on. In one embodiment, the multi-sensing device 704 powers on when it is inserted into the filter assembly 112, or when a data port cable supplies power to the multi-sensing device 704 after either the multi-sensing device has been removed from the filter assembly 112 or the battery 1014 has been completely drained due to extended inactivity. Power for the multi-sensing device 704 may be provided by various types of power sources. For example, the multi-sensing device 704 may be powered by the battery 1014, the energy harvesting device 1024 and the energy harvesting control circuitry 1026, or power provided by the aircraft or machine in which the hydraulic system 100 resides.

The method 1200 continues in block 1204 where it is determined whether there are any alarms stored in the flash memory 1006. For example, if the multi-sensing device 704 has been inactive for an extended period of time, the current drawn by the multi-sensing device 704 may fully drain the battery 1014. If it is determined that alarms are set in the flash memory 1006, the method 1200 continues to block 1206 where the alarms are loaded into the microcontroller 1002 for use in the main processing loop 1250 and the status LEDs 712 (e.g., temperature status LED, pressure status LED, fluid quality status LED, battery status LED, and data status LED) changed in accordance with the stored alarm states. However, if there are no alarms set in the flash memory 1006, the method 1200 continues to block 1208 where the default alarm states are loaded into the microcontroller 1002 for use in the main processing loop 1250. For example, the default alarm states include no alarms.

The method 1200 continues to block 1210 where the flash memory 1006 is checked to determine if threshold levels have been stored in the memory. For example, the threshold levels may be stored in the flash memory 1006 by a user programming these values. If it is determined that threshold levels are found in the flash memory 1006, the method 1200 continues to block 1212 where the threshold levels are loaded from the flash memory 1006 into the microcontroller 1002 for use in the main processing loop 1250. If it is determined that the threshold levels are not stored in the flash memory 1006, the method 1200 continues to block 1214 where default threshold levels are loaded into the microcontroller 1002 for use in the main processing loop 1250. In the present embodiment, the threshold levels may include temperature threshold levels, pressure differential threshold levels, fluid quality threshold levels, and/or other threshold levels.

The method 1200 continues in block 1216 where the multi-sensing device 704 enters a loop of continuously acquiring and storing sensor data and battery data. For example, the sensor data includes temperature data from the temperature sensor circuit 724, pressure data from the pressure sensor circuit 726, and fluid quality data from the fluid contamination sensor circuit 728 of FIG. 3. In one embodiment, the sensor data and battery data acquisition loop is operable when the temperature of the hydraulic fluid is above a predetermined value. This ensures that the hydraulic fluid has been flowing in the hydraulic system 100 for a sufficient amount of time such that the collected data is valid and proper. That is, the hydraulic fluid has been flowing in the hydraulic system 100 under operating conditions for a sufficient period of time. In one embodiment, a predetermined value of 99° F. is loaded into the microcontroller 1002 for use in the main processing loop 1250. The predetermined value is loaded from the user programmed threshold levels in the flash memory 1006 (block 1210) or from the default threshold levels stored in the flash memory 1006 (block 1214).

For example, when the hydraulic fluid temperature is above the predetermined threshold value, a sampling frequency is approximately 100 Hz. In this case, every 25 samples are averaged so that the multi-sensing device 704 determines the sensor status and battery status approximately every 0.25 seconds. In one embodiment, the hydraulic fluid temperature is assumed to meet the minimum temperature criteria the first time through the sensor data and battery data acquisition loop. The method 1200 continues to block 1218 where it is determined whether the hydraulic fluid temperature is above the predetermined value of 99° F. If not, the method 1200 proceeds to block 1220 where temperature data is acquired, for example every 30 seconds, and continues to acquire temperature data until the fluid temperature is above 99° F. The method 1200 continues to block 1222 where it is determined whether the hydraulic fluid temperature is above 99° F. If the fluid temperature falls below the predetermined threshold value, then the method 1200 loops back to block 1220 and continues to acquire temperature data periodically, for example every 30 seconds, until the hydraulic fluid temperature is above the predetermined threshold value of 99° F. When the hydraulic fluid temperature is above the predetermined threshold value of 99° F., the method 1200 loops back to block 1216.

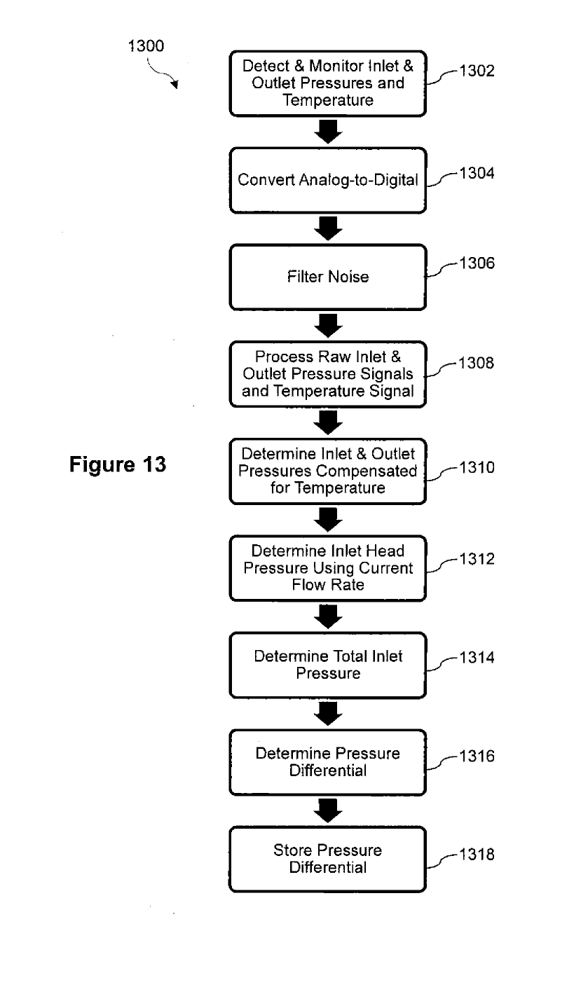

As discussed above, at block 1216 the multi-sensing device 704 enters a loop of continuously acquiring and storing sensor data. Part of acquiring and storing sensor data includes determining the pressure differential across filter element 732 (FIG. 9) of filter assembly 112 using the current flow rate of the hydraulic fluid. FIG. 13 illustrates a method 1300 for determining the pressure differential across a filter element using the current flow rate of the hydraulic fluid.

At step 1302, with reference to FIG. 9, the inlet pressure sensor 734 detects and monitors the pressure on the inlet side 729 of filter element 732 and outlet pressure sensor 736 detects and monitors the pressure on the outlet side 730 of filter element 732. Additionally, temperature sensor circuit 724 senses a temperature of the hydraulic fluid passing through the filter assembly 112. At step 1304, analog-to-digital converter 1004 receives the analog signals from the pressure sensor circuit 726 and temperature sensor circuit 724 and converts these analog signals into digital signals. Then, at step 1306, the digital pressure signals are subjected to a digital filter which removes anomalies/electrical noise from the digital pressure signals.

At step 1308, the microcontroller 1002 receives the filtered digital pressure signals and the digital temperature signal. The microcontroller 1002 processes the filtered digital pressure signals into a raw inlet pressure signal and a raw outlet pressure signal that originated from the inlet and outlet pressure sensors 734 and 736, respectively. Also, the microcontroller 1002 processes the digital temperature. In that regard, as one skilled in the art would understand, microcontroller 1002 utilizes the Steinhart-Hart temperature equation to determine the temperature of the hydraulic fluid within filter assembly 112. Microcontroller 1002 stores the determined temperature in memory 1006.

Next, at step 1310, microcontroller 1002 adjusts the raw inlet pressure signal and the raw outlet pressure signal by accounting for the affect that the determined temperature has on the respective pressures. In that regard, microcontroller 1002 utilizes the following formula to determine the inlet pressure compensated for temperature:

$$Pcomp ( inlet ) = \{ \begin{matrix}( \frac{15}{{10}^{- 7.04 * {10}^{- 3} * ( T - 100 ) + 1.176}} ) * Praw ( inlet ) , 100 ° F . \leq T < 125 ° F . \\ ( \frac{15}{{10}^{- 6.2 * {10}^{- 3} * ( T - 125 ) + 1}} ) * Praw ( inlet ) , 125 ° F . \leq T < 150 ° F . \\ ( \frac{15}{{10}^{- 4.43 * {10}^{- 3} * ( T - 150 ) + 0.845}} ) * Praw ( inlet ) , 150 ° F . \leq T < 183 ° F . \\ ( \frac{15}{{10}^{- 3.73 * {10}^{- 3} * ( T - 183 ) + 0.699}} ) * Praw ( inlet ) , 183 ° F . \leq T < 209 ° F . \\ ( \frac{15}{{10}^{- 4.03 * {10}^{- 3} * ( T - 209 ) + 0.602}} ) * Praw ( inlet ) , 209 ° F . \leq T < 255 ° F .\end{matrix}$$

Wherein Pcomp(inlet) is the inlet pressure compensated for temperature; Praw(inlet) is the raw inlet pressure signal; and T is the temperature determined by microcontroller 1002 utilizing the Steinhart-Hart temperature equation.

Additionally, microcontroller 1002 utilizes the following formula to determine the outlet pressure compensated for temperature:

$$Pcomp ( outlet ) = \{ \begin{matrix}( \frac{15}{{10}^{- 7.04 * {10}^{- 3} * ( T - 100 ) + 1.176}} ) * Praw ( outlet ) , 100 ° F . \leq T < 125 ° F . \\ ( \frac{15}{{10}^{- 6.2 * {10}^{- 3} * ( T - 125 ) + 1}} ) * Praw ( outlet ) , 125 ° F . \leq T < 150 ° F . \\ ( \frac{15}{{10}^{- 4.43 * {10}^{- 3} * ( T - 150 ) + 0.845}} ) * Praw ( outlet ) , 150 ° F . \leq T < 183 ° F . \\ ( \frac{15}{{10}^{- 3.73 * {10}^{- 3} * ( T - 183 ) + 0.699}} ) * Praw ( outlet ) , 183 ° F . \leq T < 209 ° F . \\ ( \frac{15}{{10}^{- 4.03 * {10}^{- 3} * ( T - 209 ) + 0.602}} ) * Praw ( outlet ) , 209 ° F . \leq T < 255 ° F .\end{matrix}$$

Wherein Pcomp(outlet) is the outlet pressure compensated for temperature; Praw (outlet) is the raw inlet pressure signal; and T is the temperature determined by microcontroller 402 utilizing the Steinhart-Hart temperature equation.

Unlike traditional multi-sense devices, at step 1312 multi-sense device 704 determines inlet head pressure (or dynamic inlet pressure) using the current flow rate data of the hydraulic fluid received from static flow sensor 108 via communication line 114. In other words, multi-sense device 704 is taking into consideration the actual (or current or real-time) flow rate of the hydraulic fluid within hydraulic system 100 when determining the inlet head pressure (i.e. the inlet head pressure compensated for current flow rate). Microcontroller 1002 utilizes the following formula to determine the inlet head pressure:

q=½*ρv²

Wherein q is inlet head pressure compensated for current flow rate of the hydraulic fluid; ρ is the density of the hydraulic fluid; and v is the current flow rate of the hydraulic fluid within system 100.

Next, method 1300 at step 1314 in which the microcontroller 1002 utilizes the inlet head pressure compensated for the current flow rate of the hydraulic fluid and the inlet pressure compensated for temperature to determine the total inlet pressure. Microcontroller 1002 utilizes the following formula to determine the total inlet pressure:

P₀=q+Pcomp(inlet)

Wherein P₀ is the total inlet pressure; q is the inlet head pressure compensated for the current flow rate of the hydraulic fluid; and Pcomp(inlet) is the inlet pressure compensated for temperature.

At step 1316, the microcontroller 1002 determines the pressure differential across filter element 732. In that regard, the pressure differential is determined by the flowing formula:

P_{Diff}=Pcomp(outlet)−P₀

Wherein P_{Diff} is the pressure differential across the filter element; Pcomp(outlet) is the outlet pressure compensated for temperature; and P₀ is the total inlet pressure. The pressure differential is stored in memory 1006 at step 1318.

Accordingly, as shown above in method 1300, multi-sense device 704 of system 100 accounts for the current/actual flow rate of the hydraulic fluid within system 100 when determining the pressure differential across filter element 732. Thus, multi-sense device is not limited to a predetermined, fixed, constant, and/or assumed flow rate for the hydraulic fluid like traditional multi-sense devices when determining pressure differential. Instead, multi-sense device 704 accounts for fluctuation and/or variance of the flow rate of hydraulic fluid within a hydraulic line. Therefore, by accounting for the current flow rate of hydraulic fluid multi-sense device 704 more accurately determines pressure differential than traditional devices that have an error of about +/−15% by not considering the current/actual flow rate of the hydraulic fluid in the hydraulic system.

Returning to method 1200 of FIG. 12, when the hydraulic fluid temperature is above the predetermined threshold value of 99° F., the method proceeds to block 1224. At block 1224 it is determined whether any of the sensor data and battery data exceeds the predetermined warning thresholds. These warning threshold levels may be loaded from the flash memory 1006 as discussed above with respect to block 1212 or initialized to default values as discussed in block 1214.

It is understood that the warning and alert thresholds are automatically calculated for each of the temperature threshold, pressure threshold, and fluid quality threshold stored in memory 1006. In that regard, the sensor data are provided by each of the sensing modalities (e.g., temperature sensor circuit 724, pressure sensor circuit 726, and fluid contamination sensor circuit 728). The sensor data (e.g., temperature, pressure differential, and fluid quality data) includes an average of a group of 25 samples. If the averaged sensor data from any one of the sensing modalities exceeds its corresponding warning threshold, the method 1200 continues to block 1226.

It should be noted that the warning threshold for the pressure differential data corresponds to a potentially condemned condition of the filter element (e.g., blockage due to a condemned filter element), the warning threshold (different from the predetermined threshold discussed above) for the temperature data corresponds to a potential problem in the hydraulic system (e.g., overheating of the fluid), and the warning threshold for the fluid quality data corresponds to a potential problem with the hydraulic fluid (e.g., contamination of the oil). In block 1226, one of the status LEDs 712 is a warning LED that is activated to blink periodically. For example, the warning LED blinks within a period of not more than one second and a duty cycle of not more than 20%. It is understood that the blinking warning LED corresponds to one or more of the temperature status LED, pressure status LED, fluid quality status LED, and battery status LED and depends on which data exceeded its corresponding warning threshold. If the sensing modality is temperature or pressure, the method 1200 continues to block 1228 where its warning count/time is also updated. The warning count/time corresponds to the number of times and total time the collected temperature and pressure differential data have exceeded the corresponding warning and alert thresholds. This information may confirm the reliability and proper operation of the multi-sensing device to accurately detect potential problems of the hydraulic system 100.

The method 1200 continues to block 1230 in preparation to record the sensor data into the flash memory 1006. In block 1230, it is determined whether the flash memory 1006 is full. If the flash memory 1006 is full, the method 1200 continues to block 1232 where the warning LED continues to blink rapidly until the sensor data and status is reset. Accordingly, this will ensure that a maintenance technician or other user of the multi-sensing device takes appropriate action such as extracting the stored data and erasing the data to free-up memory for further operation. If the flash memory 1006 is not full, the method 1200 proceeds to block 1234 where the sensor data are recorded into the flash memory 1006. After recording the data, the method 1200 loops back to block 1216 in the main processing loop 1250.

If the sensor data (from the sensing modalities) does not exceed its corresponding warning threshold as determined in block 1224, the method 1250 continues to block 1236 where it is determined whether the sensor data exceeds its corresponding predetermined alert threshold. If yes (which means that the sensor data is between the warning threshold and the alert threshold), the method 1200 continues to block 1238 where the warning LED is activated to blink periodically. For example, the warning LED blinks with a period of no more than ten seconds and a duty cycle of no more than 20%. It should be noted that the blinking of the warning LED in the warning condition (e.g., the sensor data exceeds the warning threshold) may be faster than the blinking of the warning LED in the alert condition so that a maintenance technician or other user of the multi-sensing device can differentiate between the two conditions and can take appropriate and/or remedial action. It should also be noted that the alert threshold corresponds to a less severe condition as compared to the warning threshold. That is, the alert threshold indicates that the sensor data is near a potential problem discussed above and that some component of the hydraulic system may require further evaluation.

If the sensing modality is temperature or pressure differential, the method 1200 continues to block 1240 where its alert count/time is also updated. The alert count/time corresponds to the number of times and total time the collected temperature and pressure data has exceeded the corresponding warning and alert thresholds. This information may confirm the reliability and proper operation of the multi-sensing device to accurately detect potential problems of the hydraulic system.

The method 1200 continues to block 1230 in preparation to record the sensor data into the flash memory 1006. In block 1230, the method 1200 determines whether the flash memory 1006 is full. If full, the method 1200 continues to block 1232 where the warning LED continues to blink rapidly until the sensor data and status is reset. Accordingly, this will ensure that a maintenance technician or other user of the multi-sensing device take appropriate action. If not full, the method 1200 proceeds to block 1234 where the sensor data is recorded into the flash memory 1006. After recording the data, the method 1200 loops back to block 1216 in the main processing loop 1250.

If the sensor data (from the sensing modalities) does not exceed the predetermined alert threshold value as determined in block 1236, the method 1200 continues to 1230. As discussed above, in block 1230 the method 1200 determines whether the flash memory 1006 is full. If full, the method continues to block 1232 where the warning LED continues to blink rapidly until the sensor data and status is reset. If not full, the method 1200 proceeds to block 1234 where the sensor data is recorded to the flash memory 1006. After recording the data, the method 1200 loops back to block 1216 in the main processing loop 1200.

It is understood that the sensor data that is stored in memory may be time stamped so that a history log of the sensor data may be provided to a maintenance technician during a regularly scheduled maintenance check of the hydraulic system. Further, although both a warning threshold and alert threshold have been disclosed above, it is understood that only a warning threshold, or only an alert threshold, or any number of warning and alert threshold values may be used as well.

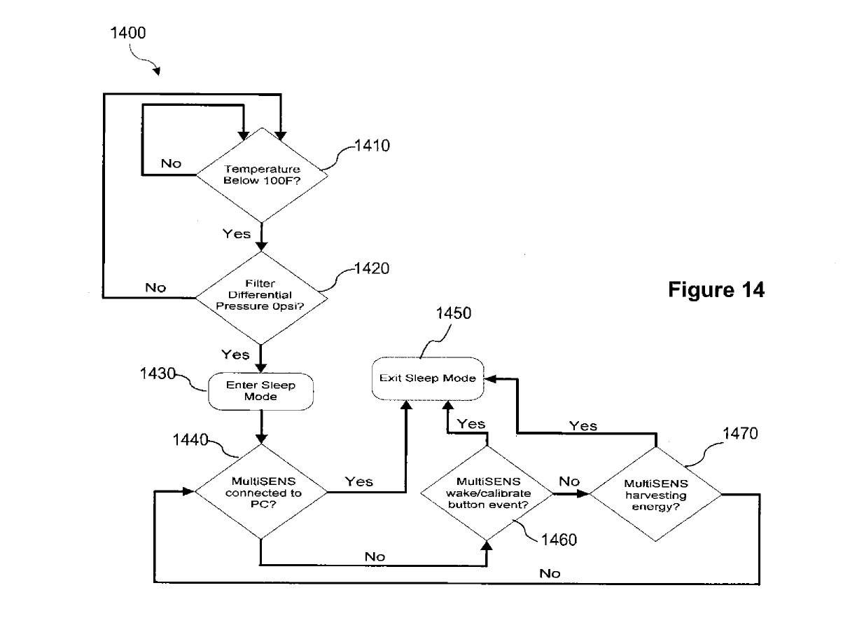

Referring to FIG. 14, illustrated is a flowchart of a method 1400 for a sleep mode operation of the multi-sensing device 704. The sleep mode operation of the multi-sensing device 704 is implemented when the hydraulic system 100 is in non-use, for example, when the aircraft is not in operation. The method 1400 begins in block 1410 where it is determined whether the temperature of the hydraulic fluid, such as oil, is below a predetermined threshold value, for example, 100° F. If the oil temperature is not below the predetermined threshold value, the hydraulic system 100 is likely either in operation or has recently shut down. In this case, the multi-sensing device 704 remains in operation and therefore, the method 1400 remains at block 1410. If the oil temperature is below the predetermined threshold value, the hydraulic system 100 is likely either not in operation or is starting up. Therefore, the multi-sensing device 704 may enter the sleep mode, depending on various other measurements, for example, the filter pressure differential state. In this case, the method 1400 proceeds to block 1420 where it is determined whether the differential pressure (i.e. pressure differential across the filter element) is at or about a predetermined threshold value, for example, 0 psi. If yes, the method 1400 proceeds to block 1430 where the multi-sensing device 704 enters the sleep mode. In no, the method 1400 proceeds to block 1410 discussed above.

After entering the sleep mode, the method 1400 proceeds to block 1440 where it is determined whether the multi-sensing device 704 is connected to a diagnostic or computing device, for example, a PC. If connected, the method 1400 proceeds to block 1450 where the multi-sensing device 704 exits the sleep mode and returns to normal operation (i.e. method 1200 of FIG. 12). If not connected, the method 1400 proceeds to block 1460 where it is determined if the wake/calibrate button 720 has been selected. If selected, the method 1400 continues to block 1450 where the multi-sensing device 704 exits the sleep mode and returns to normal operation. If not selected, the method 1400 continues to block 1470 where it is determined whether the multi-sensing device 704 is harvesting energy (e.g., the aircraft's engine is started). If harvesting energy, the method 1400 proceeds to block 1450 where the multi-sensing device 704 exits the sleep mode and returns to normal operation. If not harvesting energy, the method 1400 proceeds to block 1440 discussed above.

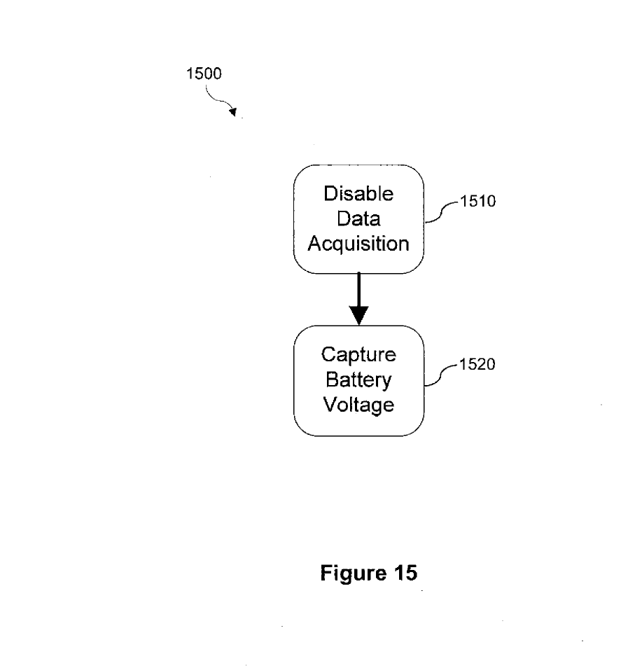

Referring to FIG. 15, illustrated is a flowchart of a method 1500 for when the multi-sensing device 704 is connected to a diagnostic or computing device, such as a PC. The method 1500 begins at block 1510 where the main processing loop 1250 of the normal operation method 1200 is exited, thereby disabling acquisition of sensor and battery information at block 1216. The method 1500 continues to block 1520 where a battery voltage is captured, which is used to calculate the remaining life of battery 1014. During the time when the multi-sensing device 704 is connected to the PC, the PC begins to recharge the battery 1014 via the data communication port 1010. For example, the data communication port 1010 may be configured as a USB port which is capable of supplying power to recharge the battery.

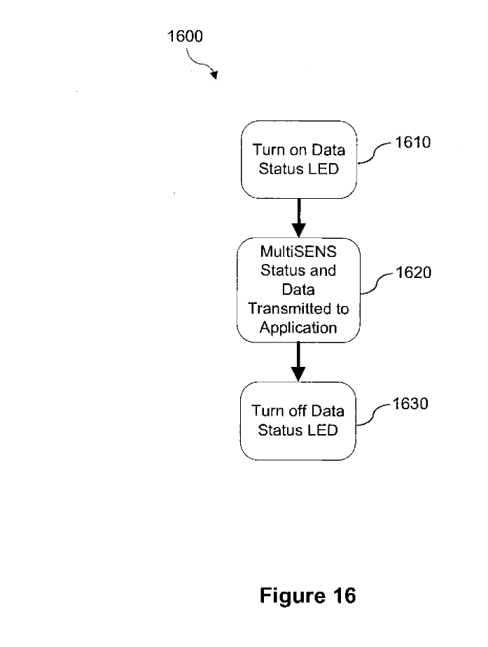

Referring to FIG. 16, illustrated is a flowchart of a method 1600 for data extraction from the multi-sensing device 704. The method 1600 begins executing when a data extraction application is opened while the multi-sensing device 704 is connected to the PC. The data extraction method 1600 begins in block 1610 where a data status LED (one of the status LEDs 712) is turned on. The data status LED indicates that the communication connection between the multi-sensing device 704 and the data extraction application has been made, and the data extraction application is ready to upload sensor and battery data from multi-sensing device 704. Also, the data status LED indicates to the user that the communication cable between the PC and the multi-sensing device 704 should not be removed while the data status LED is on. The data extraction method 1600 continues in block 1620 where the status and data of the multi-sensing device 704 is automatically uploaded to the data extraction application. In one embodiment, the data is stored as comma separated values and therefore, the data is exportable to a variety of different data storage and processing applications as is known in the art. After data and status information is transmitted from the multi-sensing device 704 to the data extraction application running on the PC, the method 1600 proceeds to block 1630. In block 1630, the data status LED is turned off, indicating that it is safe to remove the communication cable between the PC and the multi-sensing device 704.

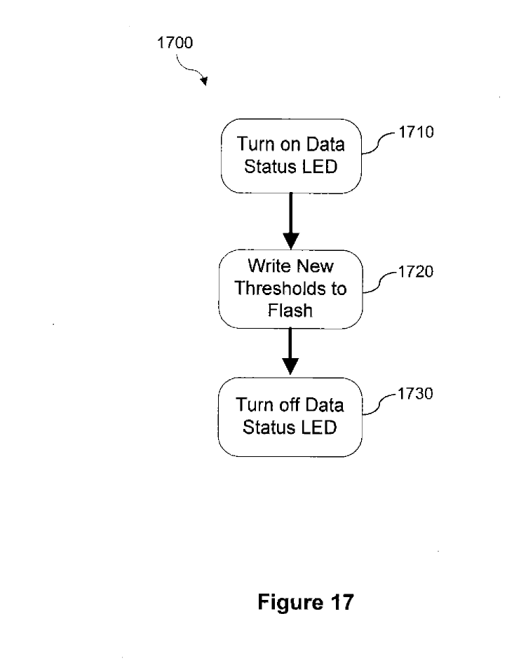

Referring to FIG. 17, illustrated is a flowchart of a method 1700 for configuring threshold values for the multi-sensing device 704. A user may use a data extraction application to program threshold values for the multi-sensing device 704. For example, the user is able to program new threshold values when either the hydraulic fluid (e.g. oil) and/or filter (e.g. oil filter) specifications or hydraulic fluid maintenance guidelines change. Initially, each multi-sensing device 704 may be pre-configured with default threshold values for a system that the multi-sensing device 704 is designed for. For example, if the multi-sensing device 704 is designed for a particular aircraft, the multi-sensing device 704 will include pre-configured threshold values set to default values associated with that particular aircraft. In an alternative embodiment, the multi-sensing device 704 may be initially configured by the user.

The threshold value programming method 1700 begins in block 1710 when the data status LED turns on to indicate that the data extraction application is prepared to communicate with the multi-sensing device 704. As discussed above when referring to the data extraction routine 1700, the data status LED indicates to the user that the communication cable between the PC and the multi-sensing device 704 should not be removed while the data status LED is on. The method 1700 proceeds to block 1720 where the user enters threshold values into the data extraction application. Also in block 1720, the data extraction application transmits the user entered threshold values into the flash memory 1006. After threshold values are stored in the stored memory 1006, the method 1700 proceeds to block 1730 where the data status LED is turned off, indicating that it is safe to remove the communication cable between the PC and the multi-sensing device 704.

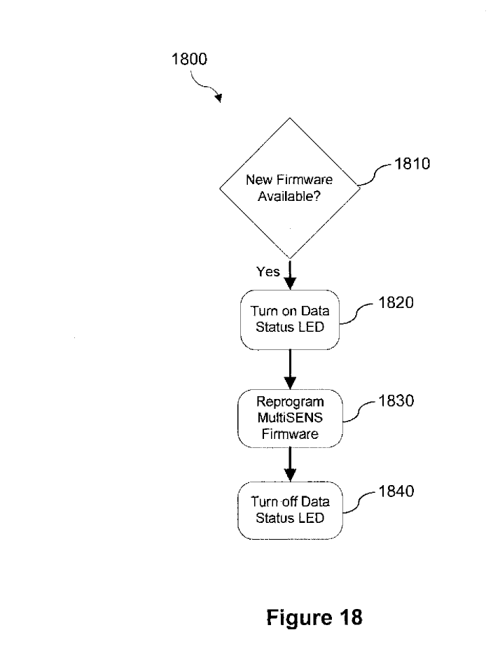

Referring to FIG. 18, illustrated is a flowchart of a method 1800 for programming firmware for the multi-sensing device 704. For example, programming firmware may be accomplished using a data extraction application running on a PC that is coupled to the multi-sensing device 704 via the data communication port 1010. The multi-sensing device 704 may initially include pre-programmed firmware. In one embodiment, firmware updates may be made available through files. For example, the files may be e-mailed, posted on servers and websites, or burned to CD-ROMs. In an alternative embodiment, firmware updates may be made available through automatic Internet updates. The firmware programming method 1800 begins in block 1810 where the data extraction application determines whether a new firmware version is available for download to the multi-sensing device 704. For example, the application looks for the new firmware version in a predetermined file storage location on the PC. If the data extraction application determines that there is a new firmware version available for download, the user is prompted accordingly. Alternatively, the user has the option of specifying the location of the new firmware version on the PC.

The method 1800 proceeds to block 1820 if the user answers the prompt by indicating that it is ok to download the new firmware to the multi-sensing device 704. The data status LED turns on, indicating that the data extraction application is prepared to communicate with the multi-sensing device 704. As discussed above, the data status LED indicates to the user that the communication cable between the PC and the multi-sensing device 704 should not be removed while the LED is on. The firmware programming method 1000 proceeds to block 1830 where the data extraction application downloads the firmware to the multi-sensing device 704. The multi-sense device 704 is reprogrammed using the downloaded firmware. Once the firmware download is complete, the method 1000 proceeds to block 1840 where the data status LED is turned off, indicating that it is safe to remove the communication cable between the PC and the multi-sensing device 704.

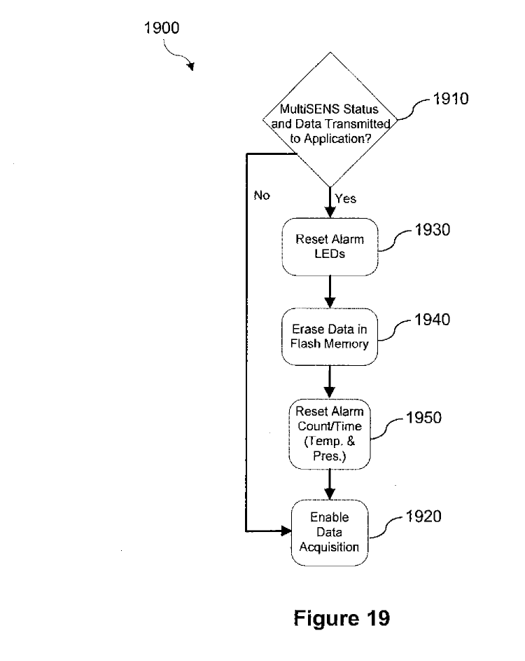

Referring to FIG. 19, illustrated is a flowchart of a method 1900 for disconnecting the diagnostic or computing device, for example a PC, from the multi-sensing device 704. Once the disconnection is made, the PC ceases charging the battery 1014. The disconnecting method 1900 begins in block 1910 where it is determined whether the status and data were successfully uploaded to the data extraction application. For example, if the communication cable between the PC and the multi-sensing device 704 was removed prematurely during the status and data upload process, then the status and data upload was unsuccessful. If unsuccessful, the method 1900 proceeds to block 1920 where the multi-sensing device 704 enters the normal operation main processing loop 1250 (See FIG. 12), thereby enabling the acquisition of, for example, sensor and battery information at block 1216. If the upload was successful, the multi-sensing device 704 will reset its alarm LEDs (in block 1930), erase the sensor and battery data that is stored in the flash memory 1006 (in block 1940), and reset the temperature and pressure alarm counters and timers (in block 1950). The method 1900 then proceeds to block 1920 discussed above.

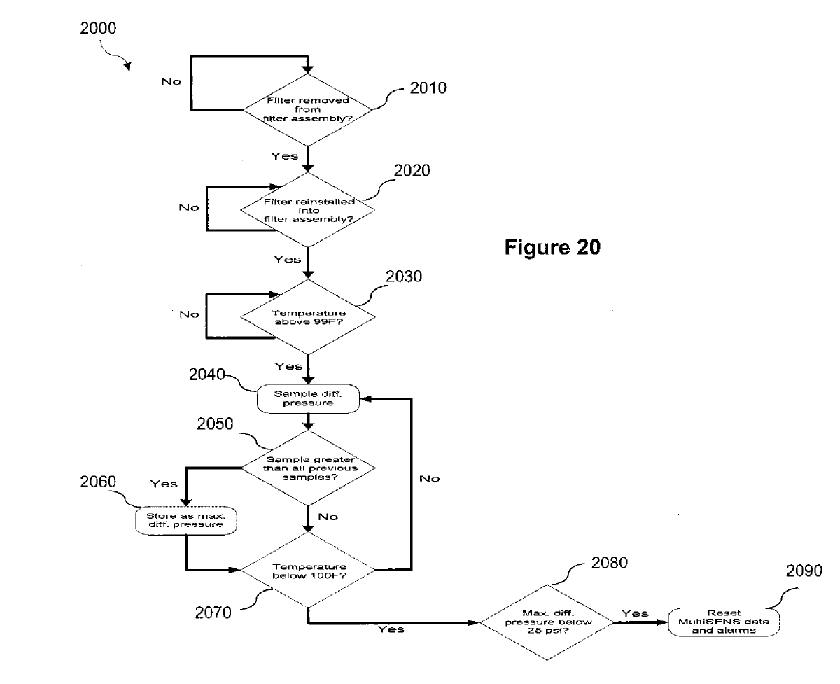

Referring to FIG. 20, illustrated is a flowchart of a method 2000 for operation of a multi-sensing device 704 during a filter element change. For example, the method 2000 assumes that during aircraft operation the hydraulic actuation actions occur unpredictably, and therefore a mechanism is required to determine whether a filter element has been removed from and reinstalled into the filter assembly. However, if it is observed that there are certain hydraulic actuation actions that are guaranteed to be performed while an aircraft is in operation (e.g., enabling the aircraft to either lift or land), and these hydraulic actuation actions cause the fluid flow rate to increase to at least 50% of its maximum, the need to sense filter element removal and reinstallation is obviated.

The method 2000 begins in block 2010 where it is determined whether a filter element (such as filter element 732 of FIG. 9) has been removed from the filter assembly 112. If no, the method 2000 remains in block 2010. If yes, the method 2000 proceeds to block 2020 where the multi-sensing device 704 ceases its main processing loop 1250 (of FIG. 12), if it is not in the sleep mode of operation, and monitors when the filter element is reinstalled into the filter assembly 112. When the filter element has been reinstalled into the filter assembly 112, the multi-sensing device 704 resumes the main processing loop 1250, if it is not in the sleep mode of operation. The method 2000 proceeds to block 2030 where it is determined whether the fluid temperature is above the predetermined threshold value of 99° F. If not above, the method 2000 remains in block 2030. If above, the method 2030 proceeds to block 2040 where a differential pressure is determined. Here, the differential pressure represents sampling the pressure differential across the hydraulic filter element while the fluid temperature remains above the predetermined threshold value of 99° F. The pressure differential can be determined according to method 1300 of FIG. 13. Specifically, the current/actual flow rate of the hydraulic fluid within system 100 is taken into consideration when determining the pressure differential. The method 2000 proceeds to block 2050 where it is determined whether the differential pressure sample exceeds all previous samples.

For example, in block 2050, the method 2000 determines whether the differential pressure sample exceeds a maximum differential pressure sample that is stored by the multi-sensing device 704 in the flash memory 1006. If the sample exceeds the maximum value, the method 2000 continues to block 2060 where the value stored as the maximum differential pressure is replaced by the sample. To that extent, the sample becomes the new maximum differential pressure that is stored in the flash memory 1006. On the other hand, if the differential pressure sample does not exceed all previous samples, the method 2000 proceeds to block 2070 to determine whether the fluid (e.g. oil) temperature falls below a predetermined threshold, for example 100° F. If block 2070 determines that the fluid temperature does not fall below the predetermined threshold, for example 100° F., the method 2000 loops back to block 2040 where the pressure differential across the hydraulic filter element is sampled. If block 2070 determines that the fluid temperature falls below the predetermined threshold, for example 100° F., the method 2000 proceeds to block 2080. In one embodiment, when the fluid temperature falls below the predetermined threshold value, for example 100° F., this means the aircraft has performed a single mission since the fluid hydraulic filter element was removed and replaced. In block 2080, the method 2000 checks if the maximum filter differential pressure during the mission was below 25 psi. If block 2080 determines that the pressure was below 25 psi, then this indicates that the hydraulic filer element was successfully changed, and it is safe to reset the data and alarms (block 2090) of the multi-sensing device 704.

Aspects of the present invention may be implemented in software, hardware, firmware, or a combination thereof. The various methods and/or routines disclosed herein, either individually or in combination, may be implemented as a computer program product tangibly embodied in a machine-readable storage device for execution by a processing unit or microcontroller. Various steps of embodiments of the invention may be performed by a computer processor executing a program tangibly embodied on a computer-readable medium to perform functions by operating on input and generating output. Additionally, various steps of embodiments of the invention may provide one or more data structures generated, produced, received, or otherwise implemented on a computer-readable medium, such as a memory.

Although embodiments of the present disclosure have been described in detail, those skilled in the art should understand that they may make various changes, substitutions and alterations herein without departing from the spirit and scope of the present disclosure. For example, although the particular embodiments illustrate specific process steps or procedures, many alternative implementations are possible and may be made by simple design choice. Some process steps may be executed in different order from the specific description herein based on, for example, considerations of function, purpose, conformance to standard, legacy structure, user interface design, and the like. Embodiments disclosed herein have been provided with reference to hydraulic systems using hydraulic oil. However, implementations of embodiments disclosed herein are not limited to any particular type of system or fluid. For example, alternative embodiments can include water filtration and motor oil filtration systems.

What is claimed is:

1. A flow sensor comprising:
a bore defined by a body of the flow sensor and extending through the flow sensor, the bore having a non-uniform cross-sectional shape;
an inlet portion coupled to a first hydraulic line portion and operable to deliver a hydraulic fluid into the bore;
an outlet portion coupled to a second hydraulic line portion and operable to deliver the hydraulic fluid away from the bore;
an inlet pressure sensor operable to monitor and detect an inlet pressure of the hydraulic fluid in a proximal portion of the bore;
a temperature sensor operable to monitor and detect a temperature of the hydraulic fluid in a middle portion of the bore;
an outlet pressure sensor operable to monitor and detect a outlet pressure of the hydraulic fluid in a distal portion of the bore; and
a microcontroller in communication with the inlet pressure sensor, temperature sensor, and outlet pressure sensor and operable to receive and process the inlet pressure, the temperature, and the outlet pressure to determine a flow rate of the hydraulic fluid.

2. The flow sensor of claim 1, wherein the proximal portion of the bore has a first cross-sectional shape and the middle portion of the bore has a second cross-sectional shape that is different than the first cross-sectional shape.

3. The flow sensor of claim 1, wherein the proximal portion of the bore has a first cross-sectional shape, the middle portion of the bore has a second cross-sectional shape, and the distal portion of the bore has the first cross-sectional shape, the first cross-sectional shape being different than the second cross-sectional shape.

4. The flow sensor of claim 1, further including an energy harvesting device that harvests one of heat, light, and/or vibration energy and converts it into electrical energy for powering the flow sensor.

5. The flow sensor of claim 1, wherein the microcontroller in determining the flow rate of the hydraulic fluid utilizes executable instructions including:
determining an inlet pressure compensated for temperature by using the flowing formula:
$$Pcomp ( inlet ) = \{ \begin{matrix}( \frac{15}{{10}^{- 7.04 * {10}^{- 3} * ( T - 100 ) + 1.176}} ) * Praw ( inlet ) , 100 ° F . \leq T < 125 ° F . \\ ( \frac{15}{{10}^{- 6.2 * {10}^{- 3} * ( T - 125 ) + 1}} ) * Praw ( inlet ) , 125 ° F . \leq T < 150 ° F . \\ ( \frac{15}{{10}^{- 4.43 * {10}^{- 3} * ( T - 150 ) + 0.845}} ) * Praw ( inlet ) , 150 ° F . \leq T < 183 ° F . \\ ( \frac{15}{{10}^{- 3.73 * {10}^{- 3} * ( T - 183 ) + 0.699}} ) * Praw ( inlet ) , 183 ° F . \leq T < 209 ° F . \\ ( \frac{15}{{10}^{- 4.03 * {10}^{- 3} * ( T - 209 ) + 0.602}} ) * Praw ( inlet ) , 209 ° F . \leq T < 255 ° F .\end{matrix}$$
wherein Pcomp(inlet) is the inlet pressure compensated for temperature, Praw(inlet) is the inlet pressure sensed by the inlet pressure sensor, and T is a temperature of the hydraulic fluid within bore calculated by the microcontroller using the temperature received from the temperature sensor;
determining an outlet pressure compensated for temperature by using the flowing formula:
$$Pcomp ( outlet ) = \{ \begin{matrix}( \frac{15}{{10}^{- 7.04 * {10}^{- 3} * ( T - 100 ) + 1.176}} ) * Praw ( outlet ) , 100 ° F . \leq T < 125 ° F . \\ ( \frac{15}{{10}^{- 6.2 * {10}^{- 3} * ( T - 125 ) + 1}} ) * Praw ( outlet ) , 125 ° F . \leq T < 150 ° F . \\ ( \frac{15}{{10}^{- 4.43 * {10}^{- 3} * ( T - 150 ) + 0.845}} ) * Praw ( outlet ) , 150 ° F . \leq T < 183 ° F . \\ ( \frac{15}{{10}^{- 3.73 * {10}^{- 3} * ( T - 183 ) + 0.699}} ) * Praw ( outlet ) , 183 ° F . \leq T < 209 ° F . \\ ( \frac{15}{{10}^{- 4.03 * {10}^{- 3} * ( T - 209 ) + 0.602}} ) * Praw ( outlet ) , 209 ° F . \leq T < 255 ° F .\end{matrix}$$
wherein Pcomp(outlet) is the inlet pressure compensated for temperature, Praw(outlet) is the inlet pressure sensed by the inlet pressure sensor, and T is the temperature of the hydraulic fluid within bore calculated by the microcontroller using the temperature received from the temperature sensor; and
determining the flow rate of the hydraulic fluid utilizes the following formula:
$$Q = {A}_{1} \sqrt{\frac{2}{ρ} * \frac{( Pcomp ( inlet ) - Pcomp ( outlet )}{{( \frac{{A}_{1}}{{A}_{2}} )}^{2} - 1}}$$
wherein Q is the flow rate of the hydraulic fluid flowing through the bore, wherein A₁ is the cross-sectional area of the proximal portion of the bore, wherein A₂ is the cross-sectional area of the middle portion of the bore, wherein Pcomp(inlet) is the inlet pressure compensated for temperature, Pcomp(outlet) is the outlet pressure compensated for temperature, and wherein ρ is the density of the hydraulic fluid.

6. The flow sensor of claim 1, further including a data communication circuit coupled to the microcontroller and in communication with a communication line that is external to the flow sensor such that the microcontroller is operable to send the determined flow rate of the hydraulic fluid to another device coupled to the second hydraulic line portion via the communication line.

7. The flow sensor of claim 1, wherein the bore further includes a first transition portion positioned between the proximal portion and the middle portion such that the first transition portion tapers from the proximal portion to the middle portion, and
a second transition portion positioned between the distal portion and the middle portion such that the second transition portion tapers from the distal portion to the middle portion.

8. A system comprising:
a flow sensor coupled to a fluid line and operable to determine flow rate data of a fluid flowing through the fluid line and communicate the flow rate data of the fluid to a multi-sense device; and
the multi-sense device coupled to the fluid line and operable to monitor characteristics of the fluid flowing through a filter element, the multi-sense device including:
a first sensor operable to sense a first pressure of the fluid on a first side of the filter element;
a second sensor operable to sense a second pressure of the fluid on a second side of the filter element; and
a third sensor operable to sense a temperature of the fluid;
an indicator for indicating a condition of the filter element; and
a microcontroller coupled to the first, second, and third sensors, the microcontroller executing instructions for:
receiving the flow rate data from the flow sensor, the first pressure of the fluid from the first sensor, the second pressure of the fluid from the second sensor; and the temperature of the fluid from the temperature sensor;
determining a pressure differential across the filter element using the flow rate data from the flow sensor, the first pressure of the fluid from the first sensor, the second pressure of the fluid from the second sensor, and the temperature of the fluid from the temperature sensor;
determining whether the temperature exceeds a temperature threshold;
if the temperature exceeds the temperature threshold, determining whether the determined pressure differential exceeds a pressure differential threshold; and
if the determined pressure differential exceed the pressure differential threshold, activating the indicator to indicate a change to the condition of the filter element.

9. The system of claim 8, wherein determining the pressure differential across the filter element includes:
determining a total pressure of the fluid on the first side of the filter element by using the flow rate data from the flow sensor, the first pressure of the fluid from the first sensor, and the temperature of the fluid from the temperature sensor;
determining a total pressure of the fluid on the second side of the filter element by using the second pressure of the fluid from the second sensor and the temperature of the fluid from the temperature sensor; and
determining the pressure differential across the filter element by comparing the total pressure of the fluid on the first side of the filter element to the total pressure of the fluid on the second side of the filter element.

10. The system of claim 8, further comprising a communication line coupling the flow sensor and the multi-sense device, wherein the flow sensor communicates the flow rate data to the multi-sense device using the communication line.

11. The system of claim 8, wherein the first side of the filter element is an inlet side of the filter element and the second side of the filter element is an outlet side of the filter element.

12. The system of claim 8, wherein the activating the indicator to change the condition of the filter element includes changing the condition of the filter element to condemned.

13. The system of claim 8, wherein the fluid is a hydraulic fluid.

14. The system of claim 8, wherein determining whether the temperature exceeds the temperature threshold includes determining whether the temperature exceeds a first temperature threshold and a second temperature threshold, and
wherein if the temperature exceeds the second temperature threshold, activating the indicator to indicate a change to a condition of the fluid.

15. The system of claim 8, wherein the multi-sense device further includes a fourth sensor for sensing a quality of the fluid flowing through the filter element.

16. A method comprising:
receiving actual flow rate data representing an actual flow rate of a fluid flowing through a fluid system, wherein the actual flow rate data is generated by sensing the fluid flowing through the fluid system;
receiving a first sensed pressure of the fluid from an inlet pressure sensor, wherein the inlet pressure sensor is on an inlet side of a filter element;
receiving a second sensed pressure of the fluid from an outlet pressure sensor, wherein the outlet pressure sensor is on an outlet side of the filter element;
receiving a sensed temperature of the fluid from a temperature sensor;
determining a pressure differential across the filter element using the flow rate data, the first sensed pressure, the second sensed pressure, and the sensed temperature;
determining whether the sensed temperature exceeds a temperature threshold;
if the sensed temperature exceeds the temperature threshold, determining whether the determined pressure differential exceeds a pressure differential threshold; and
if the determined pressure differential exceed the pressure differential threshold, determining that the filter element is in a condemned condition.

17. The method of claim 16, wherein the inlet pressure sensor, outlet pressure sensor, and the temperature sensor are components in a multi-sense device that is coupled to a fluid line of the fluid system, and
wherein the actual flow rate is determined by a flow sensor coupled to the fluid line upstream of the multi-sense device.

18. The method of claim 17 further comprising determining, by the flow sensor, the actual flow rate of the fluid flowing though the fluid system; and
sending the actual flow rate data to the multi-sense device through a communication line.

19. The method of claim 16, wherein determining the pressure differential across the filter element includes:
determining a total pressure of the fluid on the inlet side of the filter element by using the flow rate data representing the actual flow rate of the fluid flowing through the fluid system, the first sensed pressure of the fluid from the inlet sensor, and the sensed temperature of the fluid from the temperature sensor;
determining a total pressure of the fluid on the outlet side of the filter element by using the second sensed pressure of the fluid from the outlet sensor and the sensed temperature of the fluid from the temperature sensor; and
determining the pressure differential across the filter element by comparing the total pressure of the fluid on the inlet side of the filter element to the total pressure of the fluid on the outlet side of the filter element.

20. The method of claim 16, further comprising determining whether the sensed temperature exceeds another temperature threshold; and
if the sensed temperature does exceed the another temperature threshold, determining that the fluid is in an abnormal condition.
